(19) United States
(12) Patent Application Publication
(10) Pub. No.: US 2021/0007377 A1
(43) Pub. Date: Jan. 14, 2021

(54) FREEZE-DRIED FOOD PRODUCTS AND PROCESS OF PREPARING SAME

(71) Applicant: Strauss Group Ltd., Petach-Tikva (IL)

(72) Inventor: Gil DE PICCIOTTO, Zikhron Yaakov (IL)

(73) Assignee: Strauss Group Ltd., Petach-Tikva (IL)

(21) Appl. No.: 17/042,995

(22) PCT Filed: Mar. 29, 2019
(86) PCT No.: PCT/IL2019/050372

§ 371 Date: Sep. 29, 2020

(30) Foreign Application Priority Data
Mar. 29, 2018 (IL) 258463

(51) Int. Cl. A23L 7/126; A23L 3/44; A23L 29/212; A23L 33/115; A23L 33/20

(52) U.S. Cl. CPC A23L 7/126; A23L 3/44; A23V 2002/00; A23L 33/115; A23L 33/20; A23L 29/212

(57) ABSTRACT

Freeze-dried food products and processes of preparing same are provided herein. The freeze-dried food products include gelatinized starch, in an amount of at least 20% by weight of the total weight of the food product; and an oily food substance, in an amount of at least 5%, or at least 8%, by weight, of the total weight of the food product, and may further comprise additional food ingredients.

### RELATED APPLICATION/S

This application claims the benefit of priority of Israel Patent Application No. 258463 filed on Mar. 29, 2018, the contents of which are incorporated herein by reference in their entirety.

### FIELD AND BACKGROUND OF THE INVENTION

The present invention, in some embodiments thereof, relates to food products and, more particularly, but not exclusively, to freeze-dried starch-based food products featuring desirable organoleptic features, low sugar content, low Glycemic Index and low water activity, to processes of preparing same and to intermediate compositions usable thereby.

The popularity of nutrition bars and other food bars has grown rapidly in recent years. Nutrition bars are convenient vehicles for replacement of a meal and for snacks intended to boost energy.

While consumers express a preference for snacks and other foods which are more healthful, they show little inclination to sacrifice the organoleptic properties of their favorite foods or snacks. Therefore, it is important that food bars be palatable to consumers.

However, one of the main obstacles the food industry faces in producing such nutritious bars is the need to use binding agents (binders) that would “glue” all the ingredients together, without adversely affecting the product's palatability and mouth feel.

In most of the presently available commercial food bars binding agents which feature high sugar content are used. Some of the widely used sugars include glucose, fructose, sugar, honey, rice syrups and many more. Such high sugar content is often undesirable for consumers who wish to avoid sugar consumption or a sudden elevation in blood sugar, and for consumers who prefer savory rather than sweet bars. Moreover, the use of sugar-based binding agents typically require processing procedures such as elevated temperatures which adversely affect the nutritional and/or organoleptic properties of the food ingredients included in the nutritious bars.

WO 2012/078156 describes freeze-dried snack products comprising a food component at a concentration of 60-98%, by weight, a hydrolyzed whole grain composition at a concentration of up to 30% by weight, an alpha-amylase or a fragment thereof that shows no hydrolytic activity towards dietary fibers, and an emulsifier. The disclosed products may further comprise other enzymes.

U.S. patent application having Publication No. 2009/0214709 describes a non-dairy food composition based on an oil-in-water emulsion containing sugar and carbohydrates characterized in that its water activity is of between 0.5 and 0.75 and its dry matter content is of between 80 and 95% by weight. The disclosed food composition contains non-gelatinized starch whose particles size is below 10 μm.

Japanese Patent Application Publication No. JP 58212752 describes an oil-in-water emulsion having long term storage stability, prepared from a pre-emulsion containing 5 to 10% of fat and/or oil, an emulsifying agent, 5 to 40% of sugars, and 4 to 10% of chemically-processed starches.

U.S. Pat. No. 3,769,038 describes a starch-fat sponge material having a high fat content of 75-92% by weight. The material is prepared by mixing fat, water and pre-gelatinized starch and freeze-drying the formed emulsion.

WO 2016/076475 describes freeze-dried pre-gelatinized starch which is prepared by washing a raw material rice, immersing it in water, dehydrating the raw material rice, cooking it with water, cooking oil, an emulsifier and an antioxidant, quick freezing the cooked material and freeze-drying the quick-frozen raw material rice.

Kawas et al., in Journal of Food Science, Vol. 66, No. 2, pages 300-306, 2001, describes that freeze-drying tortilla chips resulted in no gelatinization of the starch, and that drying the freeze-dried chips results in a high oil content located mostly at the chip's core.

### SUMMARY OF THE INVENTION

According to an aspect of some embodiments of the present invention there is provided a freeze-dried food product comprising: gelatinized starch, in an amount of at least 20% by weight, of the total weight of the food product; and an oily food substance, in an amount of at least 5%, or at least 8%, by weight, of the total weight of the food product, the food product being a porous product.

According to some of any of the embodiments described herein, the freeze-dried food product further comprises a food ingredient.

According to some of any of the embodiments described herein, the food ingredient features at least one organoleptic and/or nutritional property that is substantially identical to the at least one property of the food ingredient when unprocessed.

According to an aspect of some embodiments of the present invention there is provided a freeze-dried food product comprising gelatinized starch and at least one food ingredient, wherein the food ingredient features at least one organoleptic and/or nutritional property that is substantially identical to the at least one property of the food ingredient when unprocessed.

According to some of any of the embodiments described herein, freeze-dried food product is a porous product.

According to some of any of the embodiments described herein, an amount of the gelatinized starch is at least 20% by weight, of the total weight of the food product.

According to some of any of the embodiments described herein, freeze-dried food product further comprises an oily food substance.

According to an aspect of some embodiments of the present invention there is provided a freeze-dried food product comprising carbohydrates and fats, wherein a total amount of the carbohydrates is at least 20% or at least 30% by weight of the total weight of the food product, and a total amount of the fats is at least 10% or at least 20% by weight of the total weight of the food product, and wherein a total amount of sugars in the food product is lower than 20% by weight of the total weight of the food product, the food product being a porous product.

According to some of any of the embodiments described herein, the carbohydrates comprise a gelatinized starch.

According to some of any of the embodiments described herein, an amount of the gelatinized starch is at least 20% by weight of the total weight of the food product.

According to some of any of the embodiments described herein, a total amount of the fats ranges from 10% to 50% by weight of the total weight of the food product.

According to some of any of the embodiments described herein, freeze-dried food product comprises at least one oily food substance.

According to some of any of the embodiments described herein, an amount of the oily food substance is at least 5% by weight of the total weight of the food product.

According to some of any of the embodiments described herein, the gelatinized starch is obtainable from a starch-containing substance.

According to some of any of the embodiments described herein, the starch-containing substance is or comprises rice.

According to some of any of the embodiments described herein, the starch-containing substance is or comprises whole rice.

According to some of any of the embodiments described herein, the starch-containing substance is or comprises whole round rice.

According to some of any of the embodiments described herein, the starch-containing substance is or comprises round rice.

According to some of any of the embodiments described herein, the starch-containing substance comprises quinoa.

According to some of any of the embodiments described herein, the starch-containing substance comprises a mixture of rice and quinoa.

According to some of any of the embodiments described herein, the rice is white round rice.

According to some of any of the embodiments described herein, the starch-containing substance comprises from 50% to 90% by weight quinoa and from 10% to 50% by weight rice, respectively, of the total weight of the starch-containing substance.

According to some of any of the embodiments described herein, a weight ratio of said rice and said quinoa ranges from 1:1 to 1:3.

According to some of any of the embodiments described herein, average amylose content in said starch-containing rice is no more than 20% by weight of the total weight of the starch-containing substance.

According to some of any of the embodiments described herein, the freeze-dried food product features, in at least a portion thereof, a plurality pores having a size of from 10 to 500, or from 50 to 350 microns.

According to some of any of the embodiments described herein, at least a portion of the pores are generally oval pores.

According to some of any of the embodiments described herein, the freeze-dried food product features at least two populations of pores, at least a first pores population comprises pores having at least one dimension lower than 200 microns, and at least a second pores population comprises pores having at least one dimension higher than 200 microns.

According to some of any of the embodiments described herein, an average width-to-length ratio of the pores in the first pores population ranges from 0.4 to 1.0, or from 0.5 to 0.8.

According to some of any of the embodiments described herein, an average width-to-length ratio of the pores in the second pores population ranges from 0.05 to 0.6, or from 0.08 to 0.5.

According to some of any of the embodiments described herein, the freeze-dried food product features a water activity lower than 0.5, or lower than 0.4, or lower than 0.3.

According to some of any of the embodiments described herein, the freeze-dried food product features a water activity in the range of from 0.05 to 0.3.

According to some of any of the embodiments described herein, a total amount of sugars is lower than 20%, or lower than 18%, or lower than 15%, by weight of the total weight of the food product.

According to some of any of the embodiments described herein, the freeze-dried food product is characterized by at least one of:

pores having a size in a range of from 10 to 500, or from 50 to 350, microns; and/or

pores as defined in any of the respective embodiments; and/or

water activity lower than 0.5, or lower than 0.4, or lower than 0.3; and/or

carbohydrate content of at least 20%, or at least 30% by weight, of the total weight of the food product; and/or

fat content of at least 10% by weight of the total weight of the food product; and/or

a total amount of sugars of less than 20% by weight of the total weight of the food product.

According to some of any of the embodiments described herein, the freeze-dried product comprises ingredients as set forth in Table 3A.

According to some of any of the embodiments described herein, the freeze-dried product comprises ingredients as set forth in Table 5A.

According to some of any of the embodiments described herein, the freeze-dried product comprises ingredients as set forth in Table 6A.

According to some of any of the embodiments described herein, the freeze-dried product comprises ingredients as set forth in Table 14A.

According to some of any of the embodiments described herein, the freeze-dried product is characterized by hardness, as defined by TPA measurements, of from 30 N to 200 N, or from 60 N to 150N.

According to some of any of the embodiments described herein, the freeze-dried product is characterized by cohesiveness, as defined by TPA measurements, of from 0.05 to 0.3, or from 0.08 to 0.25.

According to some of any of the embodiments described herein, the freeze-dried product is characterized by gumminess, as defined by TPA measurements, of from 5 N to 50 N, or from 8 N to 40 N.

According to some of any of the embodiments described herein, the freeze-dried product is characterized by springiness, as defined by TPA measurements, of from 0.2 to 1, or from 0.3 to 0.8.

According to some of any of the embodiments described herein, the freeze-dried product is characterized by a Glycemic Index, as determined by ISO 26642:2010, lower than 50, or lower than 40.

According to some of any of the embodiments described herein, the freeze-dried product is devoid of an enzyme.

According to some of any of the embodiments described herein, the freeze-dried product is devoid of an alpha-amylase.

According to some of any of the embodiments described herein, the freeze-dried product features a shape of a generally rectangular bar, a generally cylindrical bar, a generally oval bar, a generally pyramidal bar, granules, pellets and flakes.

According to some of any of the embodiments described herein, the freeze-dried product further comprises a packaging material enclosing the food product.

According to some of any of the embodiments described herein, the packaging material is gas-impermeable and/or water-impermeable.

According to an aspect of some embodiments of the present invention there is provided a process of preparing a freeze-dried food product, the process comprising: blending a starch-containing preparation comprising a gelatinized starch and water with an oily food substance, to thereby obtain a homogeneous mixture comprising the starch-containing preparation; and subjecting the mixture to freeze-drying, thereby preparing the freeze-dried food product.

According to some of any of the embodiments described herein, the process further comprises, prior to the blending, preparing the starch-containing preparation by heating a mixture of a starch-containing substance and water.

According to some of any of the embodiments described herein, the heating is at a temperature of from 50 to 99° C. or from 80 to 99° C.

According to some of any of the embodiments described herein, the heating is for a time period that ranges from 10 minutes to 5 hours, or from 20 minutes to 2 hours, or is one hour.

According to some of any of the embodiments described herein, a weight ratio of the starch-containing substance and the water ranges from 1:1 to 1:5, or from 1:2 to 1:4, or is 1:3.

According to some of any of the embodiments described herein, the process further comprises, prior to the blending, adding a food ingredient to the mixture of starch-containing preparation and the oily food substance.

According to some of any of the embodiments described herein, the process further comprises, subsequent to the blending, adding a food ingredient to the homogeneous comprising the starch-containing preparation.

According to some of any of the embodiments described herein, the food ingredient comprises a liquid or wet food ingredient.

According to some of any of the embodiments described herein, the food ingredient comprises a seasoning component.

According to some of any of the embodiments described herein, the process further comprises, subsequent to the mixing, adding to the mixture comprising the emulsion an additional amount of the starch-containing preparation.

According to some of any of the embodiments described herein, the process further comprises adding to the mixture comprising the emulsion a food ingredient.

According to some of any of the embodiments described herein, the food ingredient is a dry, solid or semi-solid, food ingredient.

According to some of any of the embodiments described herein, the food ingredient and/or the additional amount of starch-containing preparation are mixed with the emulsion to obtain a substantially even distribution thereof in the emulsion.

According to some of any of the embodiments described herein, a total amount of the starch-containing preparation in the mixture comprising the emulsion is at least 20%, or at least 24%, or at least 30%, by weight, of a total weight of the mixture.

According to some of any of the embodiments described herein, an amount of the oily food substance ranges from 5% to 20% by weight of the total weight of the mixture comprising the emulsion.

According to some of any of the embodiments described herein, the freeze-drying comprises freezing the mixture comprising the emulsion at a temperature of from −8 to −179° C., to thereby obtain a frozen emulsion.

According to some of any of the embodiments described herein, the freezing is for a time period that ranges from 2 minutes to 36 hours.

According to some of any of the embodiments described herein, the frozen emulsion is subjected to drying by lyophilization.

According to some of any of the embodiments described herein, an amount of the freeze-dried product is from 15 to 60%, or from 20 to 60%, or from 20 to 50%, or from 30 to 50%, or from 35 to 45% by weight of the total weight of the mixture comprising the emulsion.

According to some of any of the embodiments described herein, the process further comprises shaping the food product.

According to some of any of the embodiments described herein, the shaping is of the mixture comprising the emulsion, and is performed prior to the freeze-drying.

According to some of any of the embodiments described herein, the shaping is of the frozen emulsion and is performed prior to the drying.

According to some of any of the embodiments described herein, the shaping is performed subsequent to the freeze-drying.

According to some of any of the embodiments described herein, the process further comprises packaging the food product.

According to some of any of the embodiments described herein, the packaging is performed under dry and/or insert atmosphere.

According to some of any of the embodiments described herein, the packaging is in a packaging material that is gas-permeable and/or water-permeable.

According to an aspect of some embodiments of the present invention there is provided a freeze-dried food product prepared or obtainable by the process as described herein in any of the respective embodiments and any combination thereof.

According to an aspect of some embodiments of the present invention there is provided a mixture comprising a starch-containing preparation which comprises a gelatinized starch and water and an oily food substance.

According to some of any of the embodiments described herein, the starch-containing preparation is obtainable by heating a mixture of a starch-containing substance and water.

According to some of any of the embodiments described herein, the mixture further comprises a food ingredient.

According to some of any of the embodiments described herein, an amount of the starch-containing preparation is at least 30% by weight of the total weight of the mixture.

According to some of any of the embodiments described herein, the starch-containing substance is or comprises rice.

According to some of any of the embodiments described herein, an amount of the oily food substance is at least 5% of the total weight of the mixture.

According to an aspect of some embodiments of the present invention there is provided a freeze-dried food product obtainable by subjecting the mixture as described hereinabove to freeze-drying.

According to an aspect of some embodiments of the present invention there is provided a process of preparing the mixture described hereinabove, the process comprising: heating the starch-containing substance and water to thereby obtain the starch-containing preparation; and mixing the starch-containing preparation and the oily food substance under conditions that provide a homogenous emulsion, thereby preparing the mixture.

According to an aspect of some embodiments of the present invention there is provided a packaged food product comprising the food product as described herein in any of the respective embodiments and a packaging material enclosing the food product.

According to some of any of the embodiments described herein, the packaging material is gas-permeable and/or water-permeable.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flow chart depicting an exemplary process of preparing a food product according to the present embodiments.

FIGS. 2A-B (background art) present an image showing an exemplary set-up for performing texture properties analysis of a piece of cheese and an exemplary data obtained in TPA measurements.

FIGS. 3A-F present a photograph of a set-up used for TPA measurements (FIG. 3A) and data obtained in these TPA measurements of exemplary food products (Samples 1-4 and 5; FIGS. 3B-F, respectively) according to some embodiments of the present invention.

FIG. 4 presents SEM images of an exemplary food product (Sample 1) according to some embodiments of the present invention.

FIG. 5 presents SEM images of an exemplary food product (Sample 2) according to some embodiments of the present invention.

FIG. 6 presents comparative SEM images of exemplary food products (Sample 1; left images, and Sample 4; right images) according to some embodiments of the present invention.

FIG. 7 presents SEM images of an exemplary food product (Sample 4) according to some embodiments of the present invention.

FIG. 8 presents SEM images of an exemplary food product (Sample 5) according to some embodiments of the present invention.

FIG. 9 presents comparative SEM images of exemplary food products (Sample 1; left images, and Sample 6, right images) according to some embodiments of the present invention.

FIG. 10 presents comparative plots showing the blood glucose levels as measured after consuming exemplary food bars according to the present embodiments, referred to herein as Samples 5 and 6, compared with a Dextrose control. All meals contained 25 g of available carbohydrate. Data are expressed as Mean±SEM.

FIG. 11 presents comparative plots showing the blood glucose levels as measured after consuming exemplary food bars according to the present embodiments, referred to herein as Sample 7, compared with a Dextrose control. All meals contained 25 g of available carbohydrate. Data are expressed as Mean±SEM.

FIG. 12 presents the data obtained in TPA measurements for an exemplary food product (Sample 7) according to some embodiments of the present invention.

FIGS. 13A-D present SEM images of an exemplary food product (Sample 7) according to some embodiments of the present invention.

### DESCRIPTION OF SPECIFIC EMBODIMENTS OF THE INVENTION

The present invention, in some embodiments thereof, relates to food products and, more particularly, but not exclusively, to freeze-dried starch-based food products featuring desirable organoleptic features, low sugar content, low Glycemic Index and low water activity, to processes of preparing same and to intermediate compositions usable thereby.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

In a search for food products that can serve as meal replacement, such as food bars (e.g., nutritious bars) which circumvent the need to use sugars as binding agents (binders), the present inventor has designed and successfully practiced a novel methodology for producing such products, which feature a reduced sugar content while maintaining desirable organoleptic properties.

The present inventor has conceived using starch as a binding agent and, upon studying various methodologies, have uncovered that products featuring desirable organoleptic and nutritional properties are obtained when an emulsion formed of a starch-containing preparation which is obtained by heating a starch-containing substance in water, optionally in the presence of an oily (fatty) food substance is subjected to freeze-drying. The present inventor has uncovered that the combination of the starch preparation and an oily substance resulted in products featuring a desired transparent appearance and a smooth mouth feel compared to other tested combinations.

The present inventor has further realized that while using such a methodology, products featuring lower sugar content compared to products that use sugar-based binding agents can be obtained.

The present inventor has further realized that due to the mild conditions applied during the manufacturing, food ingredients that are added to the food product maintain their organoleptic and nutritional properties, as opposed to the adverse changes that such food ingredients may undergo when processed while using a sugar-based binding agent.

Embodiments of the present invention thus relate to novel freeze-dried food (e.g., nutritious) products, and to processes of preparing same. Embodiments of the present invention further relate to compositions (preparations) usable in preparing freeze-dried food products.

Food Products:

According to an aspect of some embodiments of the present invention there is provided a freeze-dried food product.

Herein throughout, the phrase “food product” describes an edible product that comprises at least two food (edible) ingredients that are bound together to form the product. This phrase relates to processed food (edible) ingredients wherein at least two food ingredients are bound to one another.

In some embodiments, the at least two food ingredients are bound to one another by physical interactions, that is, the ingredients are not bound to one another by chemical bonds but are held together and are possibly is contact with one another within the product. In some embodiments, one of the food ingredients acts as a binding agent that binds the other ingredients. In some embodiments, one of the food ingredients in dispersed in or enveloped by one or more other food ingredients.

The food product of the present embodiments comprises carbohydrates and fats, and optionally other nutritious elements such as proteins, sugars and minerals.

According to some of any of the embodiments described herein, a total amount of carbohydrates in the food product is at least 20% by weight of the total weight of the food product.

In some embodiments, a total amount of carbohydrates in the food product is at least 24%, at least 25%, at least 27%, at least 29%, at least 30%, at least 35%, or at least 40%, by weight, of the total weight of the food product.

In some embodiments, a total amount of carbohydrates in the food product is in a range of from 20 to 60%, or from 25 to 60%, or from 30 to 60%, or from 30 to 50%, or from 20 to 50%, or from 25 to 50%, or from 30 or 50%, by weight, of the total weight of the food product, including any intermediate values and subranges therebetween.

Herein throughout, the term “carbohydrates” encompasses materials (molecules) containing mainly carbon, oxygen and hydrogen atoms, and are typically polyhydroxy aldehydes, ketones, alcohols, acids, simple derivatives thereof and polymers thereof which may have acetal linkages. Carbohydrates are typically divided into simple carbohydrates, which include sugars and oligosaccharides, and complex carbohydrates, which include mainly polysaccharides.

Sugars typically include monosaccharides, disaccharides and polyols. Monosaccharides are consisted of a single saccharide (sugar) molecule which cannot be further decomposed by hydrolysis. Examples include, without limitation, glucose, galactose, fructose, and xylose. Disaccharides are consisted of two monosaccharide molecules linked to one another. Examples include, without limitation, sucrose, lactose, maltose and trehalose. Polyols are molecules that include a plurality of hydroxy groups, such as, but not limited to, sorbitol and mannitol.

The term “sugar content” in the context of food products in general and in the context of the present embodiments, encompasses a total sum of monosaccharides and disaccharides, as is referred to also by regulatory authorities such as the FDA and the Israeli regulation authority (Food Control Services, Ministry of Health).

Oligosaccharides typically include from 3 to 10 monosaccharide units linked to one another and include, for example, malto-oligosaccharides such as maltodextrins, and oligosaccharides such as raffinose, stachyose and fructo-oligosaccharides.

Polysaccharides include more than 10 monosaccharide units linked to one another, and can include dozens or hundreds monosaccharide units. Polysaccharides can be liner or branched, and may include also other atoms such as nitrogen and sulfur. The most abundant polysaccharides are known as starch, and include, for example, amylose, amylopectin, and modified starches. Other exemplary polysaccharides include, without limitation, cellulose, hemi-cellulose, pectins, and hydrocolloids.

Carbohydrates also encompass digestible carbohydrates and non-digestible carbohydrates, which are also called carbohydrate fibers, or simply fibers.

According to some of any of the embodiments described herein, a total amount of fats (including saturated and unsaturated fats) is at least 20% by weight of the total weight of the food product.

In some embodiments, a total amount of fats in the food product is at least 25%, or at least 30%, by weight, of the total weight of the food product.

According to some of any of the embodiments described herein, a total amount of fats (including saturated and unsaturated fats) is no more than 70%, preferably no more than 60%, or no more than 50%, or no more than 45%, by weight of the total weight of the food product.

In some embodiments, a total amount of fats in the food product is in a range of from 20 to 50%, or from 20 to 45%, or from 30 or 45%, by weight, of the total weight of the food product, including any intermediate values and subranges therebetween.

Herein throughout, the term “fats” encompasses any edible lipid substance, including triglycerides, other substances that comprise fatty acids or esters thereof, other lipids, such as steroids, and/or oils. Lipids are typically hydrophobic substances, which are soluble in organic solvents and insoluble in water, or, in other words, have a Log P value (for octanol/water) higher than 1. Lipids can be divided into fatty substances that are solid in room temperature and those that are liquid or semi-solid in room temperature. Fatty substances (fats, lipids) that are liquid or semi-solid in room temperature are also referred to herein and in the art as “oils” or “oily substances” or “oily food substances”.

Fats encompass substances that comprise saturated, unsaturated and trans fatty acids. Fats can be derived from plant, mineral or animal origin. Edible fats are typically derived from plant or animal origin.

The fats in a food product as described herein can be obtained from an oily substance that is added to the product and/or from fat-reach food ingredients such as nuts, seeds, some fruits and vegetables, and some dairy substances, when these are added to the food product.

According to some of any of the embodiments described herein, a total amount of sugars, as defined herein, in the food product is no more than 20%, preferably no more than 18%, or no more than 16%, or no more than 15%, or no more than 12%, or no more that 10%, of the total weight of the food product.

In some embodiments, the sugars included in the food product of the present embodiments, come from food ingredients such as fruits and vegetables that are added to the food product, as opposed to currently available food products which use sugars to bind food ingredients together in the final product.

Without being bound by any particular theory, it is noted that, as discussed in the Background section hereinabove, currently available food products as defined herein typically feature much higher sugar content since, in addition to sugars that are present in food ingredients that are added to the food product, sugar-based substances are used to bind the food ingredients within the product. Thus, the methodology described herein advantageously allows the provision of food products that feature relatively low sugar content.

A food product as described herein is made of carbohydrates and fats, and may optionally comprise in addition sugars, proteins, and minerals.

According to some of any of the embodiments described herein, a food product as described herein comprises:

Carbohydrates, in a total amount of at least 20%, or at least 30%, by weight, of the total weight of the food product, for example, from 20% to 60%, or from 30% to 50%, by weight, of the total weight of the food product, of which a total amount of sugars is no more than 20%, or no more than 18%, or no more than 16%, by weight, of the total weight of the food product, for example, from 10% to 16%, by weight, of the total weight of the food product; and

Fats, in a total amount of at least 20%, by weight, of the total amount of the food product, for example, from 20 to 60%, or from 20 to 50%, by weight, of the total amount of the food product.

According to some of any of the embodiments described herein, the food product further comprises one or more proteins.

According to some of these embodiments, a total amount of the proteins ranges from 5% to 40%, or from 5% to 30%, of from 10% to 30%, or from 10% to 20%, or from 5% to 25%, by weight, of the total weight of the food product, including any intermediate values and u=subranges therebetween.

According to some of any of the embodiments described herein, the food product further comprises minerals such as sodium.

According to some of these embodiments, an amount of the minerals is lower than 1% by weight of the total weight of the food product, and can range, for example, from 0.01 to 1%, or from 0.01 to 0.5%, or from 0.01 to 0.2%, or from 0.05 to 0.15%, by weight, of the total weight of the food product, including any intermediate values and subranges therebetween.

By “freeze-dried” it is meant that a product was subjected to freeze-drying at one of the final stages of its preparation, preferably upon introducing all the food ingredients included therein.

As is well known in the art, freeze-drying is a procedure in which a product or substance that contain water is frozen and thereafter subjected to drying by effecting sublimation of the water, typically by applying reduced pressure.

According to some of any of the embodiments described herein, the food product as described herein is porous.

By “porous” it is meant that the food product is composed of a bulk and voids (pores, empty spaces or holes) within the bulk. The voids can be of different sizes and can be evenly or randomly distributed within the food product.

A porous product according to the present embodiments can be defined by its void fraction (porosity), which is the relative volume portion of the voids out of the total volume of the product.

In some embodiments, the porous food product features an average porosity, as defined herein, of at least 20%, or of at least 30%, or of at least 40%, or of at least 50%, and up to 90%, including any intermediate values and subranges therebetween. By “average porosity” it is meant the total void volume out of the total volume of the product, while considering that a non-uniform porosity of the product.

In some embodiments, the food product features an uneven porosity such that in one or more portions of the product, the porosity is of 30% or higher, and in one or more other portions of the product, the porosity is of less than 30%, and can be even nullified.

In some embodiments, the food product features, in at least a portion thereof (e.g., a portion that has porosity other than 0), a plurality of pores, each independently having a size of from 10 to 500, or from 50 to 350 microns.

In some embodiments, the pores are generally oval pores, having a round-like shape of an elongated sphere, such that the diameters at two perpendicular slices of the pore are different from one another. In some embodiments, at least 20% of the pores in the food product are oval, and in some embodiments, at least 30%, or at least 40%, or at least 50%, or at least 60%, or at least 70%, or at least 80%, or at least 90%, of the pores in the food product are oval pores.

In some embodiments, the pores can be divided into two or more populations, by their size, such that one portion of the pores feature a first size and at least one another portion of the pores feature a second size, different from the first size.

In some embodiments, the food product features at least two populations of pores as follows: a first pores population in which the pores have at least one dimension lower than 200 microns (small pores), and a second pores population in which the pores have at least one dimension higher than 200 microns (large pores).

The dimension used to divide the pores into different populations according to these embodiments can be, for example, the largest diameter of an ellipse, the smallest diameter of an ellipse, the length of the longest distance possible from one side of the ellipse to the other, which cut through the ellipse lengthwise, also referred to herein as “height”, and the length of the shortest distance possible from one side of the ellipse to the other, also referred to herein as “width”.

The dimensions of pores can be measured by means well known in the art, for example, by using SEM images of the pores.

In some embodiments, the larger pores, of a second population as defined herein, are more elongated oval pores than the smaller pores. A degree of elongation can be determined, for example, by average width-to-height ratio of the pores in each population.

In some embodiments, the first pores population, of smaller pores, has an average width-to-height ratio that ranges from about 0.4 to about 1.0 or from about 0.5 to about 0.8, including any subranges and intermediate values therebetween.

In some embodiments, the second pores population, of larger pores, has an average width-to-height ratio that ranges from about 0.05 to about 0.6 or from about 0.08 to about 0.5, including any subranges and intermediate values therebetween.

Without being bound by any particular theory, it is assumed that the porous structure of the food product is, at least in part, a result of the freeze-drying process, and can further be a result of freeze-drying an emulsion which comprises water drops dispersed in a continuous hydrophobic phase, such that the pores are formed upon sublimation of water during freeze-drying. Still without being bound by any particular theory, it is assumed that the size and the shape of the water drops in the emulsion, which determines the size and shape of the formed pores, is dictated by the composition of the emulsion, for example, by the ratio between the gelatinized starch and the water in the emulsion, and/or by an oily substance when added to the emulsion, and/or by the size and shape of food additives when included in the emulsion, as is discussed in further detail hereinunder in the context of the process.

In some of any of the embodiments described herein, the food product is characterized by a water content (amount of water) in the food product lower than 10%, or lower than 8%, or lower than 6%, or lower (e.g., from 1 to 5%) by weight, of the total weight of the food product.

In some of any of the embodiments described herein, the food product is characterized by relatively low water activity.

The phrase “water activity”, abbreviated as Aw, is widely used in the food industry to define the availability of water in a food product, and is typically indicative of the stability of the food product during time, or its shelf-life, since higher water activity support the growth of microorganisms. Water activity is also indicative of the degree of moisture migration within a food product that comprises different ingredients, since moisture tends to migrate from ingredients of high water activity to ingredients of low water activity, and such a migration may affect the organoleptic properties of the product.

Water activity is determined as the partial vapor pressure of water in a substance divided by the standard state partial vapor pressure of water, typically the partial vapor pressure of pure water at the same temperature. In most cases, water activity is not proportional to the water content of a food product.

Water activity values are determined using well-known hygrometer measurements, for example, by a resistive electrolytic hygrometer, a capacitance hygrometer or a dew point hygrometer.

In some embodiments, a water activity of the food products described herein is determined using a device as described in the Examples section that follows.

In some of any of the embodiments described herein, the food product is characterized by a water activity lower than 0.5, or lower than 0.4, or lower than 0.3.

In some of any of the embodiments described herein, the food product is characterized by a water activity in the range of from 0.05 to 0.3, or of from 0.05 to 0.2, or of from 0.08 to 0.18, or from 0.1 to 0.25, or from 0.15 to 0.25, or from 0.2 to 0.25, including any intermediate values and subranges therebetween.

In some of any of the embodiments described herein, the food product comprises, as part of its carbohydrates content, gelatinized starch.

The term “starch”, which is also known as “amylum”, as used herein and in the art, generally describes a polymeric carbohydrate made of a large number of glucose units linked to one another by glycosidic bonds. Pure starch is a white, tasteless and odorless powder that is insoluble in cold water or alcohol. Starch is typically extracted from raw agricultural materials, typically cereals. The starch is consisted of two types of carbohydrates: helical amylose, which is mostly linear, and amylopectin, which is branched. The molecular weight of amylose is much smaller than that of amylopectin.

The ratio between these carbohydrates varies according to its agricultural source from which the starch is derived, and is generally in a range of from about 20 to about 30% amylose and about 70 to about 80% amylopectin, by weight. However, there are several starch sources in which the amylose:amylopectin ratio is much lower such that the content of amylose is lower than 20%, and can be even lower than 5%, by weight.

Table I below presents the weight ratios of amylose and amylopectin in exemplary agricultural starch sources, as taken from El Seoud et al., Molecules 2013, 18, 1270-1313.

TABLE I

| Starch | % | % |
|---|---|---|
| Source | Amylose | Amylopectin |
| Rice (Japonica) | 17.5 | 82.5 |
| Wheat (Asw) | 21.7 | 78.3 |
| Barley (Bomi) | 27.5 | 72.5 |
| Maize (Normal) | 21.5 | 78.5 |
| Maize (Hylon 7) | 58.6 | 41.4 |
| Water Chestnut | 23.3 | 76.7 |
| Chestnut | 19.6 | 80.4 |
| Sago | 24.3 | 75.7 |
| Lotus root | 15.9 | 84.1 |
| Kuzu root | 21 | 79 |
| Sweet Potato | 18.9 | 81.1 |
| Yam | 22 | 78 |
| Lentil | 29-45 | 71-54 |
| Tapioca | 16.7 | 83.3 |
| Arrowroot | 25.6 | 74.4 |
| Edible Canna | 22.2 | 77.8 |
| Potato | 21 | 79 |
| Waxy Maize | <1 | >99 |
| Corn | 24-28 | 75 |
| Waxy Corn | 0 | 100 |

Starch molecules are arranged in the agricultural material as semi-crystalline granules, of varying sizes, depending on the plant, typically in a range of from about 2 μm and up to 100 μm.

Agricultural materials (e.g., plants) that are rich is starch and/or are typically used as a source for extracting starch therefrom include, but are not limited to, maize (corn), wheat, potato, tapioca, quinoa and rice.

When starch is heated in water, the granules swell the water and burst, the semi-crystalline structure is lost and the smaller amylose molecules leach out of the granule, forming a fibrous network that holds water, thereby increasing the mixture's viscosity. This process is referred to in the art as starch gelatinization, and the obtained “hydrogel-like” structure is referred to herein and in the art as “gelatinized starch”. When gelatinized starch is left to cool, the original semi-crystalline structure partially recovers, and the starch paste thickens, while expelling the water. This phenomenon is called retrogradation of the amylose.

In some of any of the embodiments described herein, an amount of the gelatinized starch is at least 20% by weight of the total weight of the food product.

In some of any of the embodiments described herein, an amount of the gelatinized starch ranges from about 15% to about 30% by weight of the total weight of the food product, including any subranges and intermediate values therebetween.

In some of any of the embodiments described herein, an amount of the gelatinized starch ranges from about 20% to about 30% by weight of the total weight of the food product, including any subranges and intermediate values therebetween.

In some of any of the embodiments described herein, an amount of the gelatinized starch ranges from about 15% to about 25% by weight of the total weight of the food product, including any subranges and intermediate values therebetween.

In some of any of the embodiments described herein, an amount of the gelatinized starch ranges from about 18% to about 22% by weight of the total weight of the food product, including any subranges and intermediate values therebetween.

In some of any of the embodiments described herein, an amount of the gelatinized starch ranges from about 20% to about 25% by weight of the total weight of the food product, including any subranges and intermediate values therebetween.

In some of any of the embodiments described herein, the gelatinized starch is obtainable from a starch-containing substance, which can be a raw agricultural material (e.g., plant) or a processed material or food product made therefrom. Exemplary starch-containing substances include, but are not limited to, pure starch (extracted from a starch-containing substance or synthetically prepared), rice, including white rice, whole rice, black rice, brown rice, wild rice, Jasmin rice, basmati rice, sticky rice (e.g., sticky sushi rice) and any other type of rice, each can be regularly shaped or round, and any combination of the foregoing, wheat, barley, amaranth, quinoa, oat, teff, tapioca, potato, corn, millet and other types of crops that contain starch.

In some of any of the embodiments described herein, the starch-containing substance from which the gelatinized starch is obtained comprises one starch-containing substance, or a mixture of two or more starch-containing substances.

In some of any of the embodiments described herein, the starch-containing substance, including a mixture of two or more starch-containing substances, is selected such that an average content of the amylose therein is no more than 20% by weight, of the total weight of amylose and amylopectin.

Without being bound by any particular theory, it is assumed that since amylose is more hygroscopic than amylopectin, using a starch-containing substance featuring a low amylose content and a lower amylose to amylopectin ratio may render the final freeze-dried food product less hygroscopic and hence may provide a freeze-dried food product that features improved mouse feel (a less dry mouse feel). Furthermore, and again without being bound by any particular theory, it is assumed that such a low amylose-amylopectin ratio (that is, a lower content of amylose and a higher content of amylopectin) may enhance the binding capability of the gelatinized starch, and thereby allow using a lower amount of gelatinized in the final food product, without compromising its binding functionality.

By “an average content of amylose”, it is meant the total amylose content relative to the total weight of the starch-containing substance (before gelatinization). This average content, in weight percents, can be calculated as the relative amount, in weight percents, of a starch-containing substance×the relative amylose content, in weight percents, in this starch-containing substance, divided by 100. In case of a single starch-containing substance, the average content of amylose would be the weight percents of amylose in that substance. In case of two or more starch-containing substances, the average would be a sum of the relative amount, in weight percents, of each starch-containing substance×the relative amylose content in a respective substance, divided by 100. For example, if the amylose contact in a first substance is 50%, and in a second substance it is 20%, and the amount of the first substance is 20% and of the second 80%, an average amylose content would be: (50×20+20×80)100=26%.

Exemplary starch-containing substances that are typically characterized as containing a relatively lower amount of amylose (e.g., lower than 20%, or even lower than 10% by weight, or even lower than 5% by weight), relative to the total amount of amylose and amylopectin) include those shown as such in Table I above, as well as other substances, such as, for example, quinoa.

In some of any of the embodiments described herein, the starch-containing substance comprises at least 30% by weight or at least 40%, or at least 50%, or at least 60% or at least 70%, or more, by weight, of the total weight of the starch-containing substance, or is consisted of, a starch-containing substance that contains a lower amylose content as described herein.

In some embodiments, the starch-containing substance is such that features an amylose content, as defined herein, lower than 20% by weight, or lower than 10%, and even lower, of the total weight of the starch-containing substance.

In some embodiments, the starch-containing substance is such that features an amylose content, as defined herein, that ranges from about 1 to about 20%, by weight, or from about 2% to about 20%, or from about 3% to about 20%, or from about 3% to about 15% or from about 1% to about 15%, or from about 3% to about 15%, including any intermediate values and subranges therebetween, of the total weight of the starch-containing substance.

In some embodiments, a mixture of two or more starch-containing substances is used, and the substances, and they relative amount in the starch-containing substance are selected such that the average amylose content in the starch-containing substance is lower than 20% by weight, of the total amount of the starch-containing substance.

In some embodiments, the mixture of the starch-containing substances is such that features an average amylose content, as defined herein, that ranges from about 1 to about 20%, by weight, or from about 2% to about 20%, or from about 3% to about 20%, or from about 3% to about 15% or from about 1% to about 15%, or from about 3% to about 15%, including any intermediate values and subranges therebetween, of the total weight of the mixture of the starch-containing substances.

In exemplary embodiments, the starch-containing substance is or comprises rice.

In exemplary embodiments, the starch-containing substance is or comprises round rice.

In exemplary embodiments, the starch-containing substance is or comprises whole rice.

In exemplary embodiments, the starch-containing substance is or comprises whole round rice.

In exemplary embodiments, the starch-containing substance is or comprises white rice.

In exemplary embodiments, the starch-containing substance is or comprises white round rice, such as, for example, sticky sushi rice.

In exemplary embodiments, the starch-containing substance is or comprises a mixture of rice, as described herein in any of the respective embodiments, and one or more other starch-containing substances.

In exemplary embodiments, the starch-containing substance is or comprises a mixture of rice, as described herein in any of the respective embodiments, and one or more other starch-containing substances which feature relatively low amylose content as described herein.

In exemplary embodiments, the starch-containing substance is or comprises a mixture of rice, as described herein in any of the respective embodiments, and quinoa.

In exemplary embodiments, the starch-containing substance comprises from 10% to 50% by weight rice and from 50% to 90% by weight quinoa, of the total weight of the starch-containing substance.

In exemplary embodiments, the starch-containing substance comprises from 60% to 80% (e.g., about 70%) by weight quinoa and from 20% to 40% (e.g., about 30%) by weight rice, of the total weight of the starch-containing substance.

In exemplary embodiments, a weight ratio of the rice and the quinoa in the starch-containing substance ranges from 1:1 to 1:3, and can be, for example, 1:1, 1:2, 2:3, or 3:4.

In some of any of the embodiments described herein for a mixture of rice and quinoa as the starch-containing substance, the rice is white rice, preferably round white rice, as described herein.

In exemplary embodiments, the starch-containing substance is or comprises a mixture of rice, as described herein in any of the respective embodiments, and one or more other starch-containing substances which feature relatively low amylose content as described herein, and the relative amount of each starch-containing substance is selected such that an average amylose content in the mixture of the starch-containing substances is lower than 20% by weight, as described herein in any of the respective embodiments.

In exemplary embodiments, the starch-containing substance comprises from 10% to 50% by weight rice and from 50% to 90% by weight of a starch-containing substance featuring a low amylose content as described herein (e.g., lower than 20% by weight), of the total weight of the starch-containing substances.

In exemplary embodiments, the starch-containing substance comprises from 60% to 80% (e.g., about 70%) by weight of a starch-containing substance featuring a low amylose content as described herein, and from 20% to 40% (e.g., about 30%) by weight rice, of the total weight of the starch-containing substances.

In exemplary embodiments, the rice species is selected as featuring a high amylopectin: amylose content.

In exemplary embodiments, a weight ratio of the rice and the starch-containing substance that features a low amylose content as described herein in the starch-containing substance ranges from 1:1 to 1:5, and can be, for example, 1:1, 1:2, 1:3, 1:4, 1:5, 2:3, 2:5, 3:5, 4:5 or 3:4.

In some of any of the embodiments described herein, the gelatinized starch in the food product refers to the broken form of the starch's semi-crystalline structure, formed upon heating a starch-containing substance in water, and upon subjecting the obtained gelatinized starch to freeze-drying, where a major portion (e.g., at least 80%, or at least 90%, or at least 95%, or more, of the available water (water that is not included inside a food ingredient) is removed. Without being bound to any particular theory, it is assumed that the gelatinized starch in the food product comprises the fibrous three-dimensional network formed during starch gelatinization, which holds therein starch molecules, and any of the other food ingredients included in the food product.

In some of any of the embodiments described herein, the food product comprises at least one oily food substance.

The present inventors have uncovered that an addition of an oily food substance provides an improved mouth feel to the food product.

An “oily food substance”, which is also referred to herein as an “oily substance” or as a “liquid fatty substance” describes a lipid or fat, as defined herein, which is liquid or semi-solid at room temperature.

In some of any of the embodiments described herein, an amount of the oily food substance is at least 5% by weight of the total weight of the food product.

In some of any of the embodiments described herein, an amount of the oily food substance ranges from 5% to 25%, or from 5% to 20%, or from 5% to 15%, or from 8% to 25%, or from 8% to 20%, or from 5% to 10%, or from 8% to 10%, of the total weight of the food product, including any intermediate values and subranges therebetween.

Exemplary oily food substances that are usable in the context of the present embodiments include, but are not limited to, a vegetable oil, tahini, a nut butter (e.g., almond butter), a nut paste (e.g., almond paste), a seed butter, mayonnaise, an oily dairy substance, a fish oil, ghee, and an edible mineral oil.

Exemplary vegetable oils include, but are not limited to, olive oil, canola oil, coconut oil, rapeseed oil, corn oil, cottonseed oil, peanut oil, saffron oil, safflower oil, sesame oil, soybean oil, palm oil, sunflower oil and any combination thereof.

Additional exemplary vegetable oils include nut oils, including, but not limited to, Almond oil, Beech nut oil, Brazil nut oil, Cashew oil, Hazelnut oil, Macadamia oil, Mongongo nut oil (or manketti oil), Pecan oil, Pine nut oil, Pistachio oil, Walnut oil, and Pumpkin seed oil.

Additional exemplary vegetable oils include citrus oils, including, but not limited to, grapefruit seed oil, lemon oil and orange oil.

Additional exemplary vegetable oils are derived from melon and gourd seeds and include, but are not limited to, Bitter gourd oil, from the seeds of Momordica charantia, Bottle gourd oil, extracted from the seeds of the Lagenaria siceraria, Buffalo gourd oil, from the seeds of the Cucurbita foetidissima, Butternut squash seed oil, from the seeds of Cucurbita moschata, Egusi seed oil, from the seeds of Cucumeropsis mannii naudin, Pumpkin seed oil, and Watermelon seed oil, pressed from the seeds of Citrullus vulgaris.

Additional exemplary vegetable oils include, but are not limited to, Açaí oil, Black seed oil, Blackcurrant seed oil, Borage seed oil, Evening primrose oil, Flaxseed oil (called also linseed oil), Amaranth oil, Apricot oil, Apple seed oil, Argan oil, Avocado oil, Babassu oil, Ben oil, Borneo tallow nut oil, Cape chestnut oil, Carob pod oil (Algaroba oil), Cocoa butter, Cocklebur oil, Cohune oil, Coriander seed oil, Date seed oil, Dika oil, False flax oil, Grape seed oil, Hemp oil, Kapok seed oil, Kenaf seed oil, Lallemantia oil, Mafura oil, Marula oil, Meadowfoam seed oil, Mustard oil Niger seed oil, Nutmeg butter, Okra seed oil, Papaya seed oil, Perilla seed oil, Persimmon seed oil, Pequi oil, Pili nut oil, Pomegranate seed oil, Poppyseed oil, Pracaxi oil, Prune kernel oil, Quinoa oil, Ramtil oil, Rice bran oil, Royle oil, Sacha inchi oil, Sapote oil, Seje oil, Shea butter, Taramira oil, Tea seed oil (Camellia oil), Thistle oil, Tigernut oil (or nut-sedge oil), Tobacco seed oil, Tomato seed oil, and Wheat germ oil.

Nut butters usable in the context of the present embodiments include, but are not limited to, peanut butter, almond butter, cashew butter, macadamia butter, peanut butter, pecan butter, pistachio butter and walnut butter.

Nut pastes usable in the context of the present embodiments include, but are not limited to, peanut paste, almond paste, cashew paste, macadamia paste, peanut paste, pecan paste, pistachio paste and walnut paste.

By “paste” it is meant herein a fine buttery product having an average particles size of no more than 50 microns, or of no more than 40, 30, or 20 microns.

Seed butters usable in the context of the present embodiments include, but are not limited to, pumpkin seed butter, sunflower seed butter, sesame seed butter (tahini), soybean butter, and any other butter produced from other edible seeds.

An oily substance according to some of the present embodiments can be an animal oil, such as schmaltz, fish oil, or a dairy oily substance (which include animal milk from cows, goats, sheep, buffaloes, horses, camels, etc.).

A dairy oily substance describes any dairy substance that has at least 1% by weight fat, e.g., 1, 3, 5, 9, 15, 25, 30%, or more, by weight, fat, including any intermediate values and subranges therebetween.

Exemplary dairy substances include, but are not limited to, skimmed milk, whole milk, buttermilk, cream, butter, cheese, whey, and yogurt, and powders of any of the foregoing.

Exemplary dairy oily substances include bur are not limited to, skimmed milk, whole milk, buttermilk, cream, butter, whey, and yogurt.

In some of any of the embodiments described herein, the oily dairy substance is yogurt, for example a yogurt of 1-10%, or 1-5% fat.

In some of any of the embodiments described herein, the oily substance is or comprises olive oil.

In some of any of the embodiments described herein, the oily substance is or comprises tahini.

In some of any of the embodiments described herein, the oily substance is or comprises olive oil and yogurt.

In some of any of the embodiments described herein, the oily substance is or comprises olive oil and tahini.

In some of the embodiments described in the context of this aspect of the present invention, the oily substance is or comprises a nut butter or paste, for example, almond paste.

In some of any of the embodiments described herein, the oily substance is or comprises olive oil and a nut butter or paste, for example, almond paste.

According to an aspect of some embodiments of the present invention there is provided a freeze-dried food product, as defined herein, which comprises:

gelatinized starch, as defined herein and described in any of the respective embodiments, in an amount of at least 20% by weight, of the total weight of the food product, as defined herein in any of the respective embodiments; and

an oily food substance, as defined herein and described in any of respective embodiments, in an amount of at least 5%, or at least 8%, by weight, of the total weight of the food product, as defined herein in any of the respective embodiments and any combination thereof.

In some of the embodiments described in the context of this aspect of the present invention, an amount of the gelatinized starch ranges from about 20 to about 30% by weight of the total weight of the food product, including any subranges and intermediate values therebetween.

In some of the embodiments described in the context of this aspect of the present invention, an amount of the gelatinized starch ranges from about 20 to about 25% by weight of the total weight of the food product, including any subranges and intermediate values therebetween.

In some of the embodiments described in the context of this aspect of the present invention, the gelatinized starch is obtainable from a starch-containing substance, as defined and described herein in any of the respective embodiments.

In some of the embodiments described in the context of this aspect of the present invention, the starch-containing substance is or comprises rice, for example, whole round rice.

In some of the embodiments described in the context of this aspect of the present invention, the starch-containing substance is or comprises rice, for example, a mixture of white round rice and quinoa, as described herein in any of the respective embodiments.

In some of the embodiments described in the context of this aspect of the present invention, an amount of the oily food substance ranges from 5 to 25%, or from 5 to 20%, or from 5 to 15%, or from 8 to 25%, or from 8 to 20%, of the total weight of the food product, including any intermediate values and subranges therebetween.

In some of the embodiments described in the context of this aspect of the present invention, the oily substance is or comprises a dairy oily substance, and in some embodiments the dairy oily substance is yogurt, for example a yogurt of 1-10%, or 1-5% fat.

In some of the embodiments described in the context of this aspect of the present invention, the oily substance is or comprises olive oil.

In some of the embodiments described in the context of this aspect of the present invention, the oily substance is or comprises tahini.

In some of the embodiments described in the context of this aspect of the present invention, the oily substance is or comprises olive oil and yogurt.

In some of the embodiments described in the context of this aspect of the present invention, the oily substance is or comprises olive oil and tahini.

In some of the embodiments described in the context of this aspect of the present invention, the oily substance is or comprises a nut butter or paste, for example, almond paste.

In some of the embodiments described in the context of this aspect of the present invention, the oily substance is or comprises olive oil and a nut butter or paste, for example, almond paste, as described herein.

In some of the embodiments described in the context of this aspect of the present invention, the food product comprising the gelatinized starch and the oily substance is porous, as defined herein in any of the respective embodiments and any combination thereof, and in some embodiments, the pores have an average size, size populations, shapes and dimensions as described herein in any of the respective embodiments related to any of the porous food products described herein.

In some of the embodiments described in the context of this aspect of the present invention, the food product comprising the gelatinized starch and the oily substance comprises carbohydrates, fats and sugars as described herein in any of the respective embodiments and any combination thereof for a freeze-dried food product.

In some of the embodiments described in the context of this aspect of the present invention, a total amount of sugars is lower than 20%, or lower than 18%, or lower than 16%, or lower than 15% by weight of the total weight of the food product, as described herein.

In some of any of the embodiments described herein, any of the freeze-dried food products of the present embodiments further comprises a food ingredient, namely, a food ingredient other than the gelatinized starch and/or the oily substance. The food ingredients can be part of the carbohydrates, fats and/or sugars in the food product, but represents an additional ingredient added to the starch base. Such a food ingredient is also referred to herein as “additional food ingredient”, or as “food additive” or as “food component”.

In some of any of the embodiments described herein, an additional food ingredient is added to the food product to provide nutritional benefits, taste and/or flavor.

Exemplary food ingredients include, but are not limited to, fruits, vegetables, nuts, seeds, legumes, solid and semi-solid dairy substances such as cheese, olives, herbs, honey and seasoning components or ingredients, and any combination thereof.

Seasoning components include, but are not limited to, salt, pepper, garlic, ketchup, tea extracts, fruit concentrates (e.g., lemon concentrate), vinegar, and any other spices.

Any of the food ingredients added to the freeze-dried food product can be in a form of a whole food ingredient, for example, whole nuts, whole seeds, whole fruit, whole olive, whole vegetable; a cut food, for example, cut fruit, cut vegetable, cut herbs, cut cheese, cut nut; a smashed food ingredients, for example, smashed fruit, smashed vegetable such as smashed carrot, smashed beetroot, and the like; mashed food, for example, mashed potatoes, tomato puree, potato puree, mashed beans, mashed pea, mashed lentils, mashed eggplant, olive spread or paste; grind food, for example, rind seeds, grind nuts, grind herbs, grind seasoning components; marinated food, for example, marinated olives, marinated pepper, marinated tomatoes; powder, for example, powdered seeds, powdered seasoning components, powdered herbs; syrup, for example, maple syrup, ketchup, concentrated tea extract; and paste, for example, olive paste, tomato paste, and the like.

Any of the food ingredients can be fresh food ingredient, frozen food ingredient, cooked food ingredient, dried food ingredient, re-hydrated dry food, and the any other form of processed food.

It is to be noted that the food ingredient may contain water (as, for example, in the case of fresh fruits and vegetables), and that during freeze-drying, some loss of water from such food component may occur (dehydration), depending on the nature of the food component. In some of any of the embodiments described herein, the food ingredient is non-synthetic, that is, it is derived from an agricultural source (e.g., plant) or animal source, and is subjected to null or mild processing such as sterilization, extraction, etc.

In some embodiments, the food ingredient is not prepared synthetically, using chemical syntheses and/or does not undergo chemical treatment.

In some embodiments, the food ingredient is a natural food ingredient as defined by Israeli Standard SI 1145, of the Standards Institution of Israel.

In some of any of the embodiments described herein, any of the freeze-dried food products described herein can further comprise additional edible components that can provide the product with desirable nutritional and/or organoleptic properties. Exemplary such components include vitamins, minerals, and the like.

In some of any of the embodiments described herein, whenever a food ingredient or any other edible component is included in the food product, it features at least one organoleptic and/or nutritional property that is substantially identical to this property of the ingredient when unprocessed. That is, a change in the property of an ingredient when included in the food product compared to the same ingredient, in the same form, when not included in the freeze-dried food product, is less than 20%, or less 10%, or less than 5%, or less than 2%, or less than 1%, or null, when the property is measurable quantitatively, and is insignificant when the property is measured qualitatively. Without being bound by any particular theory, it is assumed that such a minor or nullified change in such properties results from the delicate processing conditions by which the food product is obtainable, such that the food ingredient can undergo only mixing and freeze-drying procedures from the stage it is added and until the product is finalized. Such mild processing accounts for maintaining the organoleptic and nutritional properties of the food component substantially unchanged.

As used herein and in the art, organoleptic properties, in the context of food products, encompass any property that is conceive by an individual's sense, whereby the sense can be taste (perceived by the tongue and palate), sight (appearance, perceived by the eyes), smell (odor, aroma, perceived by the nose), touch (perceived by the hands), and mouth feel (astringency, perceived by the mouth). In some embodiments of the present invention, the individual is a human subject.

Properties such as aroma, aspects of appearance such as transparency, opacity, color strength, aspects of touch and mouth feel such as particles size, or a change in such properties, can be determined by quantitative analytical methods, which would be apparent to those skilled in the art

Other properties, or a change in the properties, are typically determined by sensory evaluation tests that are performed by a panel of trained individuals, using proven and identical test methods so as to obtain concrete and comparable information about the tested food product. Typically, each panelist involved in such tests uses a score sheet to mark his findings and the score sheets of the panelists' team are then analyzed for each individual tested product.

Common test methods include, but are not limited to, the Paired comparison test for simple difference where two coded samples are presented to the panelists for evaluation on simple difference; Triangle test where three coded samples are presented at the same time, two are identical and the third is odd and the panelist is asked to identify the odd sample; and the Hedonic scale rating test or acceptability test where samples are tested to determine their acceptability or preference.

Sensory evaluation can be performed, alternatively or in addition, while utilizing electronic sensors such as electronic tongue (e-tongue) and/or electronic nose (e-nose). Exemplary such sensors are described, for example, in Baldwin et al., Sensors (Basel). 2011; 11(5): 4744-4766.

Texture properties are typically determined by TPA, as described in further detail in the Examples section that follows.

As used herein and in the art, nutritional properties encompass the effect of a food consumed by a subject on the subject's growth, health and well-being. Nutritional properties are typically determined by the nutrients composition of the food.

In the context of the present embodiments, a change is a nutritional property is measurable by any of the techniques or methodologies known in the art for determining nutritional composition of a food product or a food component.

In the context of the present embodiments, a change in a nutritional property of a food component includes, as non-limiting examples, a change in a sugar content of the food component, a change in a carbohydrate content of the food component, a change in the ratio of saturated and unsaturated fats, etc.

According to an aspect of some embodiments of the present invention, there is provided a freeze-dried food product, as defined herein, which comprises gelatinized starch and at least one food ingredient, as defined herein, the food product being such that the food ingredient features at least one organoleptic and/or nutritional property that is substantially identical to the same property of the same food ingredient when unprocessed, as defined herein.

In some of the embodiments described in the context of this aspect of the present invention, the gelatinized starch is as defined herein in any of the respective embodiments.

In some of the embodiments described in the context of this aspect of the present invention, an amount of the gelatinized starch is as defined herein in any of the respective embodiments.

In some of the embodiments described in the context of this aspect of the present invention, an amount of the gelatinized starch is at least 20% by weight, of the total weight of the food product, as defined herein in any of the respective embodiments.

In some of the embodiments described in the context of this aspect of the present invention, an amount of the gelatinized starch ranges from about 20% to about 30% by weight of the total weight of the food product, including any subranges and intermediate values therebetween.

In some of the embodiments described in the context of this aspect of the present invention, an amount of the gelatinized starch ranges from about 20% to about 25% by weight of the total weight of the food product, including any subranges and intermediate values therebetween.

In some of the embodiments described in the context of this aspect of the present invention, the gelatinized starch is obtainable from a starch-containing substance, as defined herein in any of the respective embodiments.

In some of the embodiments described in the context of this aspect of the present invention, the starch-containing substance is or comprises rice, for example, whole round rice or a mixture of rice (e.g., white round rice) and quinoa, as described herein in any of the respective embodiments.

In some of the embodiments described in the context of this aspect of the present invention, the starch-containing substance is such that an average content of amylose therein is lower than 20% by weight, of the total weight of the starch-containing substance, as described herein in any of the respective embodiments and any combination thereof.

In some of any of the embodiments described in the context of this aspect of the present invention, the food product further comprises an oily substance, as described herein in any of the respective embodiments and any combination thereof.

In some of any of the embodiments described in the context of this aspect of the present invention, an amount of the oily food substance ranges from 5% to 25%, or from 5% to 20%, or from 5% to 15%, or from 8% to 25%, or from 8% to 20%, or from 8% to 15%, or from 8% to 12%, of the total weight of the food product, including any intermediate values and subranges therebetween.

In some of the embodiments described in the context of this aspect of the present invention, the oily substance is an oily dairy substance such as yogurt, for example a yogurt of 1-10%, or 1-5% fat.

In some of the embodiments described in the context of this aspect of the present invention, the oily substance is or comprises olive oil.

In some of the embodiments described in the context of this aspect of the present invention, the oily substance is or comprises tahini.

In some of the embodiments described in the context of this aspect of the present invention, the oily substance is or comprises yogurt.

In some of the embodiments described in the context of this aspect of the present invention, the oily substance is or comprises olive oil and yogurt.

In some of the embodiments described in the context of this aspect of the present invention, the oily substance is or comprises a nut butter or paste, for example, almond butter or paste.

In some of the embodiments described in the context of this aspect of the present invention, the oily substance is or comprises olive oil and a nut butter or paste, for example, almond paste, as described herein.

In some of the embodiments described in the context of this aspect of the present invention, the food product comprising the gelatinized starch and the food ingredient is porous, as defined herein in any of the respective embodiments and any combination thereof, and in some embodiments, the pores have an average size, size populations, shapes and dimensions as described herein in any of the respective embodiments related to any of the porous food products described herein.

In some of the embodiments described in the context of this aspect of the present invention, the food product comprising the gelatinized starch and the food ingredient, comprises carbohydrates, fats and sugars as described herein for a freeze-dried food product.

In some of the embodiments described in the context of this aspect of the present invention, a total amount of sugars is lower than 20%, or lower than 18%, or lower than 16%, or 15% by weight of the total weight of the food product, as described herein.

According to an aspect of some embodiments of the present invention there is provided a freeze-dried food product which comprises a gelatinized starch, as defined herein in any of the respective embodiments, and a carbohydrate content, fat content and/or sugar content as described herein in any of the respective embodiments.

According to an aspect of some embodiments of the present invention there is provided a freeze-dried food product which comprises a gelatinized starch, as defined herein in any of the respective embodiments, an oily substance as defined herein in any of the respective embodiments, and a food ingredient as described herein in any of the respective embodiments.

In some embodiments of these aspects of the present invention, the freeze-dried product is a porous product, as defined herein in any of the respective embodiments.

In some embodiments of these aspects of the present invention, an amount of each component is as defined herein in any of the respective embodiments.

According to some of any of the embodiments described herein, any of the freeze-dried food products described herein is porous and is characterized by at least one, at least two, at least three, at least four, at least five or all of the following characteristics:

Featuring pores having a size in a range of from 10 to 500, or from 50 to 350, microns; and/or

Featuring pores having, size populations, shapes and dimensions as described herein in any of the respective embodiments; and/or

Water activity lower than 0.5, or lower than 0.4, or lower than 0.3; and/or

Carbohydrate content of at least 20%, or at least 30% by weight, of the total weight of the food product, as described herein in any of the respective embodiments; and/or

Fat content of at least 10% by weight of the total weight of the food product, as described herein in any of the respective embodiments; and/or

A total amount of sugars of less than 20% by weight of the total weight of the food product, as described herein in any of the respective embodiments; and/or

A Glycemic Index lower than 50, or lower than 40, or lower than 30.

In some of any of the embodiments described herein, a freeze-dried food product is characterized by one or more the following texture characteristics:

Hardness, as defined by TPA measurements, of from 30 N to 200 N, or from 60 N to 150 N; and/or

Cohesiveness, as defined by TPA measurements, of from 0.05 to 0.3, or from 0.1 to 0.3, or from, 0.08 to 0.25, or from 0.12 to 0.25; and/or

Gumminess, as defined by TPA measurements, of from 5 N to 50 N, or from 8 N to 40 N, or from 10 N to 40 N; and/or

Springiness, as defined by TPA measurements, of from 0.2 to 1, or from 0.3 to 0.8.

In some of any of the embodiments described herein, a freeze-dried food product is characterized by a Glycemic Index lower than 50, or lower than 40, or even lower than 30.

In some of any of the embodiments described herein, a freeze-dried food product is characterized by a Glycemic Index that ranges from 20 to 50, or from 20 to 40, or from 25 to 40, including any intermediate value and subranges therebetween.

The above-described characteristics and methods of determining same are described in further detail in the Examples section that follows.

In some of any of the embodiments described herein, a freeze-dried food product as described herein, is devoid of an enzyme. In some embodiments, the food product is devoid of one or more, or all, of a protease, an amylase, a glucose isomerase and an amyloglucosidase.

In some embodiments, the food product is devoid of an enzyme that exhibits a hydrolytic activity towards carbohydrates.

In some embodiments, the food product is devoid of an enzyme that exhibits a hydrolytic activity towards starch, including gelatinized starch.

In some of any of the embodiments described herein, the food product is devoid of a saccharidase.

In some of any of the embodiments described herein, the food product is devoid of amylase.

Amylase (EC 3.2.1.1) is an enzyme classified as a saccharidase, which cleaves polysaccharides.

In some of any of the embodiments described herein, the food product is devoid of an alpha-amylase.

Exemplary alpha amylases include Validase HT 425L, Validase RA from Valley Research, Fungamyl from Novozymes and MATS from DSM.

In some of any of the embodiments described herein, the food product is devoid of an aminoglucosidase.

Amyloglucosidase (EC 3.2.1.3) is an enzyme which releases glucose residues from starch, maltodextrins and maltose by hydrolyzing glucose units from the non-reduced end of the polysaccharide chain.

Herein throughout, the expression “devoid of” means less than 1%, or less than 0.5%, or less than 0.1%, or less than 0.05%, or less than 0.01%, or less, or null, by weight, of the total weight of the food product.

In some of any of the embodiments described herein, the food product is devoid of hydrolyzed starch.

In some of any of the embodiments described herein, the food product comprises no more than 5%, or no more than 3%, or no more than 1%, of hydrolyzed starch.

In some of any of these embodiments, the hydrolyzed starch is a gelatinized starch that underwent hydrolytic decomposition, for example, enzymatic hydrolysis by a saccharidase.

In some of any of the embodiments described herein, the food product is devoid of an emulsifier.

In some of any of the embodiments described herein, a freeze-dried food product can further comprise antioxidants, preservatives, colorants, and like synthetic additives. In some embodiments, an amount of such additives is from 0.001 to about 5, or from 0.01 to about 2, or from 0.01 to about 1, or from 0.01 to about 0.1, weight percents, of the total weight of the food product.

In exemplary embodiments, a freeze-dried food product of the present invention comprises or consists of ingredients as set forth in Table 2A, 5A, 6A or 14A, as presented the Examples section that follows.

In exemplary embodiments, a freeze-dried food product of the present embodiments is obtainable by freeze-drying an emulsion mixture, as described and defined in further detail hereinafter, which comprises or consists of the ingredients as set forth in Table, 1, 2, 3, 4, 5, 6 or 14, as presented the Examples section that follows.

Any of the food products described herein can feature a shape of a bar, and can be considered as a snack bar, a nutritious bar, a food bar, and the like. The bar can be of any shape, and can be, for example, rectangular, oval, spherical, cylindrical, pyramidal, and like shapes.

Alternatively, the food product can be a particulate product, and can be shaped, for example, as flakes, granules, pellets, and the like.

In some of any of the embodiments described herein, the food product further comprises a packaging material in which it is enclosed or enveloped. The packaging material can be transparent or opaque, and can be made of any acceptable material or combination of materials, that are compatible with and inert to the food product. Those skilled in the art can readily determine suitable packaging materials.

In some embodiments, the packaging material is gas-impermeable and/or water-impermeable.

According to an aspect of some embodiments of the present invention there is provided a packaged food product comprising the food product as defined herein in any of the respective embodiments and a packaging material, as defined herein in any of the respective embodiments, enclosing the food product.

The Process and Intermediate Compositions:

The present inventor conducted extensive studies in a search for food products that would exhibit desired organoleptic and nutritional properties while avoiding the use of sugar binders and has designed, based on these studies, an optimal process that provides the desired product. The designed product is based on obtaining an emulsion of gelatinized starch and water, and an oily substance dispersed within said emulsion.

According to an aspect of some embodiments of the present invention there is provided a process of preparing a freeze-dried food product, which is generally effected by subjecting a starch-containing preparation which comprises a gelatinized starch and water to freeze-drying. According to some of any of the embodiments of this aspect of the present invention, the gelatinized starch is as described herein in any of the respective embodiments, and any combination thereof, including those related to a starch-containing substance.

In some embodiments, an oily food substance, as defined and described herein in any of the respective embodiments, and any combination thereof, is added to the starch-containing preparation prior to the freeze-drying, and the mixture of the starch-containing preparation and the oily substance is blended to obtain a homogeneous mixture.

In some of these embodiments, the oily substance is first blended with a portion of the starch-containing preparation and then the remaining portion of the starch-containing preparation is added, so as to assure the provision of a homogeneous mixture in which the oily substance is homogeneously (evenly) dispersed in the starch-containing preparation.

In some of these embodiments, the portion of the starch-containing preparation is from about 50% to about 90%, or from about 60% to about 80%, or from about 60% to about 70%, by weight, of the total amount of the starch-containing preparation, including any intermediate value and subranges therebetween.

In some embodiments, the blending is performed using a mechanical (e.g., commercial) blender operated at moderate to high speed, as exemplified, as a non-limiting example, in the Examples section that follows.

In some embodiments, the process is generally effected by blending a starch-containing preparation as described herein and an oily food substance as described herein, to thereby obtain a homogeneous mixture and subjecting the obtained mixture to freeze-drying.

In some of any of the embodiments described herein, the mixture containing the starch-containing preparation and optionally an oily food substance is also referred to herein as an emulsion, or as a homogeneous emulsion, or as a water-in-oil emulsion, in which water drops are dispersed with the hydrophobic gelatinized starch, along with drops of the oily substance.

In some of any of the embodiments described herein, the process further comprises, prior to the blending and/or to the freeze-drying, preparing the starch-containing preparation, as described in further detail hereinunder.

In some embodiments, a food ingredient, as described herein in any of the respective embodiments, and any combination thereof, is added to the starch-containing preparation prior to the freeze-drying.

In some embodiments, the food ingredient is added to a mixture of the starch-containing preparation and the oily substance.

In these embodiments, the food ingredient can be added either before or after the blending.

In some embodiments, a food ingredient is added to the starch-containing preparation and the obtained mixture is blended to obtain a homogeneous mixture where the food ingredient is homogeneously distributed in the starch-containing preparation.

In some embodiments, the oily substance and the food ingredient are added to the starch-containing preparation and the obtained mixture is blended to obtain a homogeneous mixture where the oily substance and the food ingredient is homogeneously distributed in the starch-containing preparation.

In some embodiments, the food ingredient and the oily substance are added together and the resulting mixture is blended, or, the food ingredient and the oily substance are added sequentially, and the obtained mixture is blended upon the addition of each.

In any of these embodiments, the food ingredient and the oily substance can be added to a portion of the starch-containing preparation and the remaining portion is added upon blending, as described hereinabove.

In some embodiments, a food ingredient is added to mixture containing the starch-containing preparation and optionally the oily substance and another food ingredient, if present, after the blending is effected, and the process comprising mixing the food ingredient with the mixture to thereby obtain an even distribution of the food ingredient. In some embodiments, the mixing is mild, and is performed under conditions that would not affect physical and organoleptic properties of the food ingredient (e.g., gentle mixing).

Typically, but not obligatory, food ingredients that are added to starch-containing preparation before blending are liquid or wet food ingredient, which should desirably be homogeneously distributed within the starch-containing preparation. Other food ingredients which should desirably be homogeneously distributed within the starch-containing preparation can also be added to the starch-containing preparation before blending, while other food ingredient are added to the preparation after the blending (if such has been effected).

Liquid food ingredients include the oily substance, and any other food ingredient that are liquid at room temperature.

Wet food ingredients include those food ingredients that are in a form a solution in water or any other aqueous solution, such as, for example, tea extracts, seeds extracts, fruit concentrates, fruit juices, vinegar, hydrated or re-hydrated ingredients, and the like.

Other food ingredients that are desirably distributed in the final product homogeneously include, for example, food ingredients that are in a powder form, for example, seasoning materials such as salt, pepper, garlic powder, or any other grinded ingredients, such as, for example, grinded herbs.

Food ingredients that are preferably added to the starch-containing preparation without being subjected to blending (after the blending if such has been effected) include solid and semi-solid ingredients such as fruits, vegetables, seeds, herbs, and the like, and/or any other food ingredients that may undergo a change in its nutritional and/or organoleptic properties if subjected to blending.

In some of any of the embodiments described herein, a total amount of the starch-containing preparation in the mixture that is subjected to freeze-drying is at least 30% by weight of a total weight of the mixture.

In some of any of the embodiments described herein, a total amount of the starch-containing preparation in the mixture that is subjected to freeze-drying ranges from about 30% to about 95%, by weight of a total weight of the mixture.

In some of any of the embodiments described herein, a total amount of the starch-containing preparation in the mixture that is subjected to freeze-drying ranges from about 20% to about 90%, or from about 24% to about 90%, or from about 30% to about 80%, or from about 30% to about 70%, or from about 30% to 60%, or from about 30% to 50%, or from about 30% to 40%, or from about 32% to 40%, or from about 34% to 40%, or from about 35% to 40%, or from about 20% to about 80%, or from about 20% to about 70%, or from about 20% to 60%, or from about 20% to 50%, or from about 20% to 40%, or from about 20% to 30%, by weight, of a total weight of the mixture, including any intermediate values and subranges therebetween.

In some of any of the embodiments described herein, a total amount of the oily substance in the mixture that is subjected to freeze-drying ranges from about 0% to about 30%, and preferably ranges from about 5% to about 30%, or from about 5% to about 20%, or from about 8% to about 20%, or from about 8% to about 15%, or from about 10% to about 20%, or from about 10% to about 15%, by weight, of the total weight of the mixture, including any intermediate values and subranges therebetween.

According to an aspect of some embodiments of the present invention, there is provided a starch-containing mixture, which comprises a starch-containing preparation which comprises a gelatinized starch and water, as described herein in any of the respective embodiments and any combination thereof, and which may optionally comprise an oily substance, as described herein in any of the respective embodiments any combination thereof.

In some embodiments of this aspect, a total amount of the starch-containing preparation in such a mixture ranges from about 20% to about 90%, or from about 24% to about 90%, or from about 24% to about 80 5, or from about 30% to about 80%, or from about 30% to about 70%, or from about 30% to 60%, or from about 30% to 50%, or from about 30% to 40%, or from about 32% to 40%, or from about 34% to 40%, or from about 35% to 40%, or from about 20% to about 80%, or from about 20% to about 70%, or from about 20% to 60%, or from about 20% to 50%, or from about 20% to 30%, by weight, of a total weight of the mixture, including any intermediate values and subranges therebetween.

In some embodiments of this aspect, a total amount of the oily substance in the mixture ranges from about 0% to about 30%, and preferably ranges from about 5% to about 30%, or from about 5% to about 20%, or from about 8% to about 20%, or from about 8% to about 15%, or from about 10% to about 20%, or from about 10% to about 15%, by weight, of the total weight of the mixture, including any intermediate values and subranges therebetween.

In some embodiments of this aspect, the mixture further comprises a food ingredient, as described herein in any of the respective embodiments.

In some of any of the embodiments of this aspect, the mixture is prepared as described herein in any of the respective embodiments for preparing a mixture that is subjected to freeze-drying.

In some of any of the embodiments of this aspect, the mixture is prepared by heating a starch-containing substance and water, as described in further detail hereinunder, to thereby obtain a starch-containing preparation, and optionally, by adding to the preparation an oily substance as subjecting the obtained mixture to blending, as described herein, to thereby obtain a homogenous mixture or emulsion, as described herein. Further optionally, a food ingredient is added to the mixture prior and/or subsequent to the blending, as described hereinabove.

In some of any of the embodiments of this aspect, the starch-containing preparation is prepared as described hereinunder.

In some of any of the embodiments of this aspect, the mixture is for obtaining a food product, upon subjecting the mixture to freeze-drying.

According to an aspect of some embodiments of the present invention, there is provided a process of preparing a food product, which comprises subjecting a mixture which comprises starch-containing preparation (a mixture comprising an emulsion as described herein) as described herein in any of the respective embodiments, to freeze-drying.

According to some of any of the embodiments described herein in the context of processes and intermediate mixtures obtained thereby or usable therein, the gelatinized starch in the starch-containing preparation is obtained from a starch-containing substance as described herein in any of the respective embodiments. In some embodiments, the starch-containing substance is rice, and in some embodiments it is while rice, for example, whole round rice.

According to some of any of the embodiments described herein in the context of processes and intermediate mixtures obtained thereby or usable therein, the oily food substance is as described herein in any of the respective embodiments. In some embodiments, the oily food substance comprises olive oil, a diary oily substance such as yogurt and/or tahini.

According to some of any of the embodiments described herein in the context of processes and intermediate mixtures obtained thereby or usable therein, the additional food ingredient, if present, is as described herein in any of the respective embodiments.

According to some of any of the relevant embodiments described herein in the context of processes and intermediate mixtures usable therein and/or obtained therefrom, the freeze-drying is effected using methods and apparatuses well-known in the art, all of which are contemplated herein.

In some embodiments, the freeze-drying comprises freezing the mixture comprising the starch-containing preparation at a temperature of from −8 to −179° C., including any intermediate value and subranges therebetween, to thereby obtain a frozen mixture.

In some embodiments, the freezing is at a temperature of from about −8 to about −100° C., or from −8 to about −80° C., or from about −8 to about −60° C., or from about −8 to about −50° C., or from about −8 to about −40° C., or from about −8 to about −30° C., including any intermediate values and subranges therebetween.

In some embodiments, the freezing is for a time period that ranges from 2 minutes to 36 hours, or from 10 minutes to 36 hours, or from 30 minutes to 36 hours, or from 1 hour to 36 hours, or from 10 minutes to 24 hours, or from 30 minutes to 24 hours, of from 1 hour to 24 hours, or from 4 hours to 36 hours, or from 4 hours to 24 hours, including any intermediate value and subranges therebetween.

In some of any of the embodiments described herein, the frozen mixture is subjected to freeze-drying using any of the known methodologies known in the art, for example, by means of a lyophilizer (lyophilization).

In some embodiments, the drying is effected until a desired water activity is achieved.

In some embodiments, the drying is effected until a water activity lower than 0.5, as described herein in any of the respective embodiments, is achieved.

The drying of the frozen mixture can be effected for a time period that ranges from 1 hour to 36 hours, or from 12 hours to 36 hours, for example, for 24 hours.

In some of any of the embodiments described herein, an amount of the freeze-dried product is from 15 to 60%, or from 20 to 60%, or from 20 to 50%, or from 30 to 50%, or from 35 to 45% by weight of the total weight of the mixture before freeze-drying. This amount corresponds to the dry-matter in the mixture before freeze-drying.

In some of any of the embodiments described herein, the process further comprises shaping the food product, to thereby obtain a final food product with a desired shape.

In some of any of the embodiments described herein, the shaping is performed prior to, during or subsequent, to the freeze-drying.

In some embodiments, shaping is performed prior to the freeze drying, for example, by placing the mixture comprising the starch-containing preparation (a mixture comprising an emulsion as described herein) in a mold having a desired shape, and subjecting the mold to freeze-drying, such that after freeze-drying, the freeze-dried food product features the shape of the mold.

In some embodiments, the shaping is performed during the freeze-drying, for example, after freezing the starch-containing preparation mixture and before drying it. In some of these embodiments, the mixture comprising the starch-containing preparation is placed is a mold, subjected to freezing, and the frozen mold-shaped mixture is shaped, before being dried. The shaping can be, for example, by cutting the mold to a desired bar shape as described herein or by forming a particulate form, such as granules, flakes, or pellets, or tablets, as described herein, and subjecting the obtained particulates to drying.

In some embodiments, the shaping is performed subsequent to the freeze-drying, for example, by cutting the freeze-dried product into a desired or shape or by forming a particulate form thereof.

In some of any of the embodiments described herein, the freeze-dried food product is subject to further processing. Such processing can include, for example, further shaping the product (in case shaping was performed prior to or during freeze-drying), coating, glazing, cooking, baking, powdering, submerging in an additional oily substance, and the like.

In some of any of the embodiments described herein, the process further comprises packaging the final food product (the freeze-dried, shaped, and optionally further processed food product).

For example, when the food product is shaped as a bar, each bar can be individually packaged, or several bars can be packaged together. When the food product is shaped as flakes, or granules, or pellets, a desired weight of the food product is packaged individually. When the food product is shaped as tablets, each tablet can be packaged individually, or several tablets can be packaged together, or each tablet is packaged individually, within a multi-package that comprises several tablets.

In some embodiments, the packaging is performed under dry and/or insert atmosphere, for example, under dry nitrogen or argon environment.

In some embodiments, the packaging is in a packaging material that is gas-permeable and/or water-permeable. Those skilled in the art would readily recognize such packaging materials. Preferably, the packaging material is such that is approved by regulatory agencies such as the FDA for food products. Further preferably, the packaging material is inert and compatible with the food product, such that it does not adhere and does not interact, chemically and/or physically, with the food product.

According to an aspect of some embodiments of the present invention there is provided a freeze-dried food product, including a packaged food product, obtainable by a process as described herein in any of the respective embodiments and any combination thereof.

According to an aspect of some embodiments of the present invention there is provided a freeze-dried food product, including a packaged food product, obtainable by a subjecting a mixture comprising a gelatinized starch-containing and water, as described herein, to freeze-drying, and optionally shaping and packaging the food product, as described herein in any of the respective embodiments and any combination thereof.

According to an aspect of some embodiments of the present invention there is provided a process of preparing a starch-containing preparation which comprises a gelatinized starch and water, as described herein, which comprises heating a mixture which comprises a starch-containing substance, as described herein in any of the respective embodiments, and water.

According to some embodiments, the heating is at a temperature of at least 40° C., or of at least 50° C., and up to the boiling point of the water. In some embodiments, the heating is at a temperature of from about 50 to about 99° C. or from about 80 to about 99° C., including any intermediate values and subranges therebetween.

According to some embodiments, the heating is for a time period that ranges from 10 minutes to 5 hours, or from 20 minutes to 2 hours, including any intermediate values and subranges therebetween, or is one hour, and in some embodiments is at a temperature as described herein.

According to some embodiments, a weight ratio of the starch-containing substance and the water ranges from 1:1 to 1:5, or from 1:2 to 1:4, including any intermediate values and subranges therebetween, or is 1:3.

In some embodiments, the obtained starch-containing preparation has a consistency that resembles porridge, and is also referred to herein as porridge-like preparation or emulsion.

According to an aspect of some embodiments of the present invention there is provided a mixture comprising a starch-containing preparation which comprises a gelatinized starch and water, as described herein, and an oily food substance, wherein the starch-containing preparation is obtainable by heating a mixture of a starch-containing substance and water, as described herein in any of the respective embodiments. In some embodiments, the mixture further comprises a food ingredient, as described herein in any of the respective embodiments.

In some embodiments, an amount of the starch-containing preparation is at least 20% or at least 30% by weight of the total weight of the mixture, as described herein in any of the respective embodiments and any combination thereof.

In some embodiments, the starch-containing substance is or comprises rice, as described herein in any of the respective embodiments and any combination thereof.

In some embodiments, an amount of the oily food substance is at least 5% of the total weight of the mixture, as described herein in any of the respective embodiments and any combination thereof.

In some embodiments, the obtained mixture is usable in preparing a freeze-dried food product as described herein in any of the respective embodiments and any combination thereof.

In some of any of the embodiments described herein, for any of the processes described herein, the process does not include an addition of an emulsifier.

In some of any of the embodiments described herein, for any of the processes described herein, the process does not include an addition of an enzyme, as described herein in any of the respective embodiments.

In some of any of the embodiments described herein, for any of the mixtures described herein, the mixture is devoid of an emulsifier.

In some of any of the embodiments described herein, for any of the mixtures described herein, the mixture is devoid of an enzyme, as described herein in any of the respective embodiments.

Exemplary processes of preparing a freeze-dried food product, and mixture which comprises or consists of a starch-containing preparation as described herein are described in the Examples section that follows.

As used herein the term “about” refers to ±10% or ±5%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

### Example 1

### Preparation of Food Bars—General Procedure

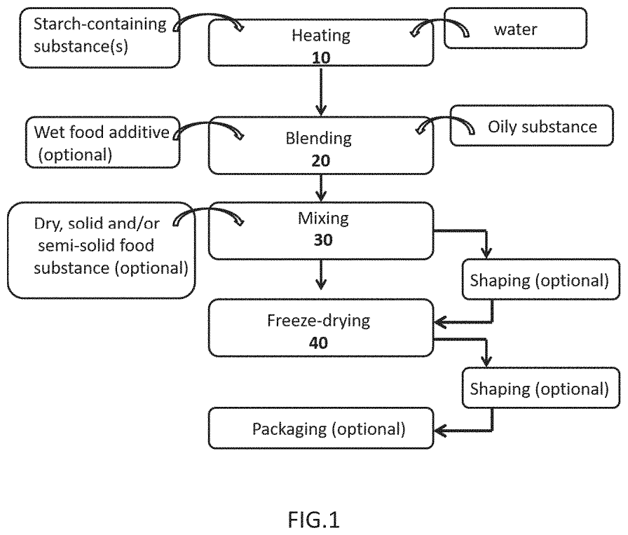

FIG. 1 depicts a flow chart presenting a general process for preparing food bars according to exemplary embodiments of the present invention.

The process starts at 10 where a gelatinized starch-containing preparation is prepared while heating a mixture of a starch-containing substance or a mixture of starch-containing substances and water, at a weight ratio that ranges from 1:1 to 1:4 (e.g., 1:3), at a temperature ranging from 60 to 100° C. (e.g., 95° C.), for a time period ranging from 10 minutes to 3 hours (e.g., one hour).

The process then continues at 20 where an oily substance (a fatty substance) is added to the gelatinized starch preparation, at a weight ratio of from about 1:1 to about 1:10 relative to the starch-containing preparation, and the obtained mixture is subjected to vigorous blending to obtain a homogeneous mixture (e.g., a mixture which comprises a homogeneous emulsion of water drops and oil dispersed in the gelatinized starch). In some embodiments, the oily substance is added to a portion of the starch-containing preparation, the obtained mixture is vigorously blended and thereafter the remaining starch-containing preparation is added. Step 20 may optionally further include an addition of a food ingredient (e.g., a liquid or wet food additive, or a food ingredient that should be homogeneously dispersed in the food product, for example, a powdery or finely grounded food ingredient such as, but not limited to, seasoning components as described herein) to the mixture of the starch preparation and the oily substance prior to the blending.

In an exemplary procedure, vigorous blending is performed while using a Thermomix® blender operated at a speed setting in a range of from 2 to 9.

The process then continues to 30 where dry, solid, semi-solid and/or liquid, food ingredient(s), if present in the final product, are added to the obtained homogeneous starch-containing mixture (comprising the starch-containing preparation and the oily substance, and optionally a food ingredient), and the obtained mixture is mixed to provide an even distribution of the food ingredients in the starch-containing mixture.

At 40 the obtained mixture (a homogeneous starch-containing mixture (emulsion) comprising the starch-containing preparation and the oily substance, and optionally food ingredient(s)), is subjected to freeze-drying. Optionally, the mixture (e.g., a mixture comprising a homogeneous emulsion as described herein) is shaped before being freezed (not shown). In exemplary embodiments, the mixture is sheeted to form a uniform layer featuring a desired thickness (e.g., in accordance with a desired thickness of the final bar product, while considering a 10-20% expansion during freezing), before it is frozen. In exemplary embodiments, the mixture is sheeted to obtain a layer having a thickness of 10-15 (e.g., 12) mm, for a final bar having a thickness of 11-18 (e.g., 14) mm. Freezing the mixture is typically performed by subjecting the mixture to a temperature of from about −5 to about −180° C., for a time period of from about 2 minutes to 36 hours. Optionally, step 40 further includes, before drying, shaping the frozen mixture into a desired shape (e.g., a final shape of the product) (not shown). For example, a uniform layer is cut into a plurality of desired shapes (e.g., into multiple bars featuring dimensions in accordance with the final shape of the bar, while considering expansion during freezing, as indicated hereinabove).

Drying is preferably effected using a lyophilizer, operated at known conditions. In the assays conducted, a LaboGene™ lyophilizer was used, and was operated at a drying pressure of about 0.001 hectapascal with shelves temperature of 35° C. for 24 hours.

Alternatively, shaping can be performed before freeze-drying, for example, by placing the mixture in shaped molds and subjecting the molds to freeze-drying. Further alternatively, shaping can be performed after freeze-drying.

The obtained product can then be packaged in an appropriate packaging material or be further processed (e.g., further shaped, coated, cooked, powdering, submerged in oily substance) and then packaged.

Preferably, each bar is packaged individually. Preferably, the packaging material is gas-impermeable and/or water-impermeable. Preferably, packaging in performed under dry and/or inert atmosphere (e.g., nitrogen environment).

In an exemplary general procedure, a food bar is prepared while using whole round rice as a starch-containing substance, a starch-containing preparation (rice preparation) prepared by heating a mixture of whole round rice and water at a weight ratio of 1:3 (e.g., 400 grams rice and 1200 grams water; which give a final preparation of about 1500 grams), at 95° C. for about one hour, and adding to the obtained preparation or to a portion thereof (e.g., about 60-70% by weight) olive oil and yogurt, or tahini, at a weight ratio of about 1:2-1:5 relative to the total weight of the obtained rice preparation. The obtained mixture is subjected to homogenization under vigorous blending using Thermomix® at speed level of 2-9, and the remaining rice preparation and additional food additives, if present, are then added to the obtained emulsion and mixed until even distribution is obtained.

The obtained emulsion is then sheeted to a uniform layer having a thickness of 12 mm, freezed at a temperature of 18 to −30° C. for 4-24 hours, the freezed sheet is cut into bars of a desired shape, size and weight, and the bars are subjected to freeze-drying using LaboGene™ lyophilizer at 0.01 hectapascal and shelves temperature of 35° C. for 24 hours.

In another exemplary general procedure, a food bar is prepared while using a mixture of white round rice and quinoa (at a weight ratio of about 2:3) as a starch-containing substance, a starch-containing preparation (rice and quinoa preparation) is prepared by heating a mixture of white round rice, quinoa and water at a weight ratio of 1:3 (e.g., 400 grams rice and quinoa and 1200 grams water; which give a final preparation of about 1500 grams), at 90° C. for about one hour, and adding to the obtained preparation or to a portion thereof (e.g., about 60-70% by weight) olive oil and almond paste, at a weight ratio of about 1:2-1:5 relative to the total weight of the obtained rice preparation. The obtained mixture is subjected to homogenization under vigorous blending using Thermomix® at speed level of 2-9, and the remaining rice preparation and additional food additives, if present, are then added to the obtained emulsion and mixed until even distribution is obtained.

The obtained emulsion is then sheeted to a uniform layer having a thickness of 14 mm, freezed at a temperature of 18 to −30° C. for 4-24 hours, the freezed sheet is cut into bars of a desired shape, size and weight, and the bars are subjected to freeze-drying using LaboGene™ lyophilizer at 0.01 hectapascal and shelves temperature of 35° C. for 24 hours.

### Example 2

### Food Bars Made of Whole Round Rice

The following describes in further detail the composition and preparation of exemplary food bars made of a whole round rice as the starch-containing substance, using the exemplary general procedure described in Example 1 hereinabove.

The weight percentages indicated in Tables 1, 2, 3, 4, 5 and 6 below refer to the mixture obtained after all the ingredients are mixed and before freeze-drying.

The weight percentages indicated in Tables 1A, 2A, 3A, 4A, 5A and 6A below refer to the final product obtained after freeze-drying the mixture as described in corresponding Tables 1, 2, 3, 4, 5 and 6.

A “rice preparation” is a starch-containing preparation as described herein, prepared by mixing whole round rice with water, at a weight ratio of about 1:3, at 95° C. for one hour.

Preparation of a “Base” Food Bar (Sample 1):

Table 1 below presents the ingredients included in a “base” food bar that comprises rice starch, olive oil and yogurt (without solid food additives and flavoring agents), before freeze-drying. The freeze-dried “base” food bar is also referred to herein as Sample 1.

TABLE 1

| Type of Ingredient | Ingredient | Weight % | |
|---|---|---|---|
| Starch-containing preparation | Rice preparation | 65-70 | (e.g., 68) |
| Oily substance | Olive oil | 8-12 | (e.g., 10) |
| | Yogurt | 20-25 | (e.g., 22) |

The “base” food bar was prepared as follows:

Rice preparation, yogurt and olive oil were mixed in “Thermomix® blender at speed level 4 for 90 seconds. The obtained mixture was sheeted using a 12 mm metal frame and frozen at −23° C. for 24 hours. The frozen sheets was removed from the freezer, cut into desired shape (22×22 mm cubes) and placed in a LaboGene™ lyophilizer at the above-specified rating,

Preparation of a “Green” Food Bar (Sample 2)

Table 2 below presents the ingredients included in a “green” food bar that comprises rice starch, olive oil and yogurt with additional liquid and/or solid food additives and flavoring agents, before freeze-drying. The freeze-dried “green” food bar is also referred to herein as Sample 2.

TABLE 2

| Type of | | | |
|---|---|---|---|
| Ingredient | Ingredient | Weight % | |
| Starch-containing | Rice preparation | 30-38 (e.g., about | |
| preparation | | 34 or about 35) | |
| Oily substance | Olive oil | 3-8 | (e.g., 5-5.2) |
| | Yogurt | 8-15 | (e.g., 11-11.5) |
| Food ingredient | Matcha tea | 0-0.1 | |
| | Kiwi | 15-25 | (e.g., 20-22) |
| | Spinach (e.g., | 0-11 | (e.g., 0 or 8-8.5) |
| | frozen) | | |
| | Kale | 0-11 | (e.g., 0 or 8-8.5) |
| | Fresh mint leaves | 0.5-2 | (e.g., 1-1.5) |
| | Honey | 1-5 | (e.g., 2-3) |
| | Ginger | 1-3 | (1.8-2.0) |
| | Roasted almonds | 11-16 | (e.g., 13-14) |
| | salt | 0.05-0.3 | (e.g., 0.1-0.2) |
| Anti-oxidant | GreenOX ® | | |
| Water | water | 1-3 | (e.g., 1.9-2.0) |

A mixture of 70% (by weight) of the rice preparation, yogurt, olive oil, 60% of the kiwi, a solution of the matcha tea powder in water (about 3% by weight of the matcha tea powder in water, at the indicated concentrations), and the antioxidant was blended at high speed until a paste was obtained. The remaining rice preparation was then added, followed by addition of the remaining kiwi (cut in 0.5×0.5 cm cubes) and roasted almonds. Spinach (frozen), if present, or Kale (if present) was then cut and added to the mixture, followed by the addition of all the remaining ingredients, and the resulting mixture was mixed to obtain even distribution.

The obtained emulsion was then subjected to freeze-drying, as described herein.

Preparation of a “Greek” Food Bar (Sample 3)

Tables 3 and 3A below present the ingredients included in “Greek” food bar that comprise rice starch and tahini/olive oil, with additional liquid and/or solid food additives and flavoring agents, before freeze-drying (Table 3) and after freeze-drying (Table 3A). The “Greek” food bar of Table 3A is also referred to herein as Sample 3.

TABLE 3

| Type of | | | |
|---|---|---|---|
| Ingredient | Ingredient | Weight % | |
| Starch-containing | Rice preparation | 35-40 | (e.g., 36-37) |
| preparation | | | |
| Oily substance | Olive oil | 0-12 | (e.g., 0 or 5-6) |
| | Tahini | 0-12 | (e.g., 0 or 10-11) |
| | Yogurt | 0-12 | (e.g., 0 or 5-6) |
| Food ingredient | Olive marinade | 3-5 | (e.g., 4) |
| | Toasted eggplant | 18-22 | (e.g., 20) |
| | Toasted pepper | 5-10 | (e.g., 8) |
| | Roasted sunflower | 15-20 | (e.g., 18) |
| | seeds | | |
| | Black pepper | 0.05-0.5 | (e.g., 0.1) |
| | Thyme | 0.3-1 | (e.g., 0.6) |
| | Salt | 0.1-0.5 | (e.g., 0.2-0.3) |
| | Dill | 0-2 | (e.g., 0 or 1) |
| | Sage | 0.3-1 | (e.g., 0.6) |
| | Parsley | 0-2 | (e.g., 0 or 1.2-1.5) |

| | | |
|---|---|---|
| Anti-oxidant | GreenOX ® | 0.001-0.1 |

TABLE 3A

| Type of | | | |
|---|---|---|---|
| Ingredient | Ingredient | Weight % | |
| Starch-containing | Rice | 20-25 | (e.g., about 22) |
| substance | | | |
| Oily substance | Olive oil | 0-5 | |
| | Tahini | 20-30 | (e.g., about 24) |
| | Yogurt | 0-5 | |
| Food ingredient | Olive marinade | 1-2.5 | (e.g., 1.8) |
| | Toasted eggplant | 5-15 | (e.g., 9) |
| | Toasted pepper | 0.5-2 | (e.g., 1) |
| | Roasted sunflower | 30-50 | (e.g., 40) |
| | seeds | | |

| | | |
|---|---|---|
| | Black pepper | 0-1 |
| | Thyme | 0-2 |
| | Salt | 0-1 |
| | Dill | 0-3 |
| | Sage | 0-2 |
| | Parsley | 0-3 |
| Anti-oxidant | GreenOX ® | 0-0.1 |

A mixture of 65-70% by weight of the rice preparation, tahini or olive oil and yogurt, and the antioxidant was blended vigorously and the remaining rice preparation was thereafter added, followed by addition of the olives (cut in rings) and the remaining ingredients. The resulting mixture was mixed to obtain even distribution, and was subjected to freeze-drying as described herein.

The weight of the mixture before drying was about 8.1 grams, and after drying about 3 grams (about 37% dry matter).

Preparation of a “Yellow” Food Bar (Sample 4)

Table 4 below presents the ingredients included in a “yellow” food bar that comprises rice starch, olive oil and yogurt with additional liquid and/or solid food additives and flavoring agents, before freeze-drying (. The freeze-dried “yellow” food bar is also referred to herein as Sample 4.

TABLE 4

| Type of | | | |
|---|---|---|---|
| Ingredient | Ingredient | Weight % | |
| Starch-containing | Rice preparation | 30-40 | (e.g., 34-36) |
| preparation | | | |
| Oily substance | Olive oil | 1-5 | (e.g., 2.5-4.5) |
| | Yogurt | 4-8 | (e.g., 6.5-7.5) |
| Food ingredient | Roasted sesame | 4-6 | (e.g., 4.2-5) |
| | seeds | | |
| | Roasted almonds | 4-12 | (e.g., 10-11 or 5-6) |
| | Mango | 18-30 | (e.g., 19-20 or 25-26) |
| | Pineapple | 8-20 | (e.g., 9-11 or 15-16) |
| | Orange peel | 0-2 | (e.g., 0 or 1.5-2) |
| | Chia pre-hydrated* | 0-5 | (e.g., 0 or 4-5) |
| | White almonds | 0-8 | (e.g., 0 or 5-6) |
| | Ginger | 1-3 | (e.g., 1-2) |
| | Salt | 0.01-0.1 | (e.g., 0.06) |

| | | |
|---|---|---|
| Anti-oxidant | GreenOX ® | 0.001-0.1 |

*Chia seeds were hydrated by being placed in water (1:3 v/v) for at least 2 hours.

A mixture of 65% (by weight) of the rice preparation, olive oil, yogurt and the antioxidant, was blended vigorously and the remaining rice preparation was thereafter added, followed by the addition of roasted almonds and sesame, diced mango, small pieces of the pineapple and the rest of the ingredients. The chia seeds were pre-soaked in water for 4 hours and mixed in the final stage of mixing. The resulting mixture was mixed to obtain even distribution, and was subjected to freeze-drying as described herein.

Preparation of a “Red” Food Bar (Sample 5)

Tables 5 and 5A below present the ingredients included in a “red” food bar that comprises rice starch, olive oil and yogurt with additional liquid and/or solid food additives and flavoring agents, before freeze-drying (Table 5) and after freeze-drying (Table 5A). The “red” food bar of Table 5A is also referred to herein as Sample 5.

TABLE 5
Type of

| Ingredient | Ingredient | Weight % | |
|---|---|---|---|
| Starch-containing | Rice preparation | 28-32 | (e.g., 28.5-50) |
| preparation | | | |
| Oily substance | Olive oil | 3-6 | (e.g., 4-4.5) |
| | Yogurt | 8-12 | (e.g., 9-10) |
| Liquid food | Green tea extract | | |
| ingredient | | | |
| Food ingredient | Honey | 1-3 | (e.g., 2-2.2) |
| | Roasted almonds | 8-12 | (e.g., 9.5-10) |
| | Sunflower seeds | 4-8 | (e.g., 6.5-7) |
| | Roasted pumpkin seeds | 0-3 | (e.g., 0 or 2) |
| | Beetroot (cooked) | 8-13 | (e.g., 10-11) |
| | Strawberry (frozen) | 24-28 | (e.g., 26-27) |
| | salt | 0.01-0.2 | (e.g., 0.08-0.1) |

| | | |
|---|---|---|
| Anti-oxidant | GreenOX ® | 0.001-0.01 |

TABLE 5A
Type of

| Ingredient | Ingredient | Weight % | |
|---|---|---|---|
| Starch-containing | Rice | 20-25 | (e.g., 21) |
| substance | | | |
| Oily substance | Olive oil | 10-15 | (e.g., 11-12) |
| | Yogurt | 3-6 | (e.g., 4-5) |
| Liquid food | Green tea extract | | |
| ingredient | | | |
| Food ingredient | Honey | 4-5 | (e.g., 4.4) |
| | Roasted almonds | 20-30 | (e.g., 26) |
| | Sunflower seeds | 10-25 | (e.g., 18) |
| | Roasted pumpkin seeds | 0-10 | |
| | Beetroot (cooked) | 3-10 | (e.g., about 5) |
| | Strawberry (frozen) | 5-15 | (e.g., about 9) |

| | | |
|---|---|---|
| | salt | 0.1 |
| Anti-oxidant | GreenOX ® | 0.0.1 |

A mixture containing 70% by weight of the rice preparation, yogurt, olive oil and the antioxidant was vigorously blended and the remaining rice preparation was thereafter added to the mixture. The almonds and sunflower seeds were roasted gently and added to the emulsion. Cooked beetroot and strawberries were cut in small cubes (approximately 0.5 cm×0.5 cm each) and added to the emulsion. The honey and salt were thereafter added, the resulting mixture was mixed to obtain even distribution, and was thereafter subjected to freeze-drying as described herein.

The weight of the mixture before drying was about 7.17 grams, and after drying about 3 grams (about 42% dry matter).

Preparation of an “Italian” Food Bar (Sample 6)

Tables 6 and 6A below present the ingredients included in an “Italian” food bar that comprises rice starch, olive oil and yogurt with additional liquid and/or solid food additives and flavoring agents, before freeze-drying (Table 6) and after freeze-drying (Table 6A). The “Italian” food bar of Table 6A is also referred to herein as Sample 6.

TABLE 6
Type of

| Ingredient | Ingredient | Weight % | |
|---|---|---|---|
| Starch-containing | Rice preparation | 32-38 | (e.g., 35-37) |
| preparation | | | |
| Oily substance | Olive oil | 1.5-2.5 | (e.g., 1.7-1.8) |
| | Yogurt | 7-10 | (e.g., 8.5-9.5) |
| Food ingredient | Basil | 3.8-4.2 | (e.g., 3.9-4) |
| | Garlic | 0.05-1 | |
| | Parmesan cheese | 1-2 | (e.g., 1.5-1.7) |
| | Olives | 7-10 | (e.g., 8-9) |
| | Roasted almonds | 10-16 | (e.g., 12-15) |
| | Tomato (puree) | 15-20 | (e.g., 17-18) |
| | Sunflower seeds | 5-10 | (e.g., 7-8) |

| | | |
|---|---|---|
| | Black pepper | 0.1-0.2 |
| | salt | 0.01-0.1 |
| | Lemon peel | 0-0.2 |
| Anti-oxidant | GreenOX ® | 0-0.01 |

TABLE 6A

| Type of | | | |
|---|---|---|---|
| Ingredient | Ingredient | Weight % | |
| Starch-containing | Rice | 20-30 | (e.g., 25) |
| substance | | | |
| Oily substance | Olive oil | 3-10 | (e.g., 4-5) |
| | Yogurt | 2-6 | (e.g., 3-4) |

| | | |
|---|---|---|
| Food ingredient | Basil | 0.5-1 |
| | Garlic | 0.1-2 |

| | | |
|---|---|---|
| Parmesan cheese | 2-4 | (e.g., about 3) |
| Olives | 2-6 | (e.g., 4.3) |
| Roasted almonds | 30-40 | (e.g., 36) |
| Tomato (puree) | 2-6 | (e.g., 3) |
| Sunflower seeds | 15-25 | (e.g., 19) |

| | | |
|---|---|---|
| | Black pepper | 0-1 |
| | salt | 0.1-1 |
| | Lemon peel | 0-1 |
| Anti-oxidant | GreenOX ® | 0-0.1 |

A mixture containing 66% by weight of the rice preparation, yogurt, olive oil, parmesan cheese, garlic, 60% by weight of the basil and the antioxidant was vigorously blended and the remaining rice preparation was thereafter added to the mixture. Olives were cut in rings and added to the obtained emulsion. The almonds and sunflower seeds were roasted gently and added to the emulsion. All other ingredients were thereafter added, the resulting mixture was mixed to obtain even distribution, and was thereafter subjected to freeze-drying as described herein.

The weight of the mixture before drying was about 7.3 grams, and after drying about 2.75 grams (about 38% dry matter).

### Example 3

### Characterization of Food Bars Made of Whole Round Rice

Texture Profile Analysis (TPA):

TPA measurements were performed using TA 500 texture analyzer by Lloyd Instruments, according to the manufacturer's instructions.

Background Art:

Texture Profile Analysis is a popular double compression test for determining the textural properties of foods. During a TPA test samples are compressed at least twice using a texture analyzer to provide insight into how samples behave when chewed, assuming that the texture analyzer mimics the mouth's biting action.

The TPA analytical method can quantify multiple textural parameters in one experiment. Typically, the measured parameters include hardness, adhesiveness and cohesiveness, and springiness, resilience, chewiness and/or gumminess can also be extracted from the obtained measurements.

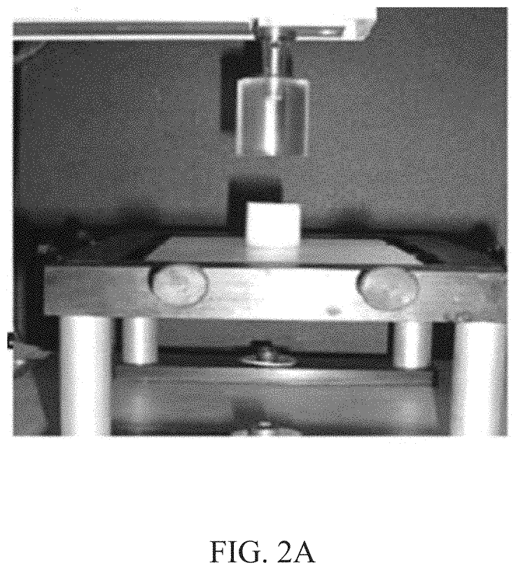

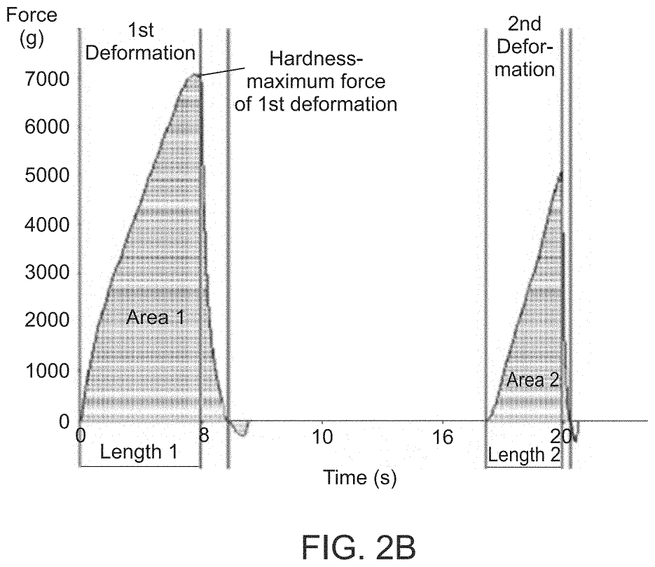

FIGS. 2A-B present an exemplary TPA set-up for measuring textural properties of a piece of a cheddar cheese (FIG. 2A) and exemplary data obtained in the analysis (FIG. 2B). The test parameters used in the exemplified analysis were as follows:

Cylindrical acrylic probe (diameter=1″; h=35 mm);

10 cylindrical samples (20 mm diameter, 20 mm height);

Test speed: 20 mm/second; distance=50% strain.

The properties measured in and/or extracted from the TPA described herein are in accordance with the acceptable definitions in related art pertaining to TPA, some of which are brought herein in a non-limiting fashion.

The term “hardness” refers to the maximum force (peak force) during the first deformation (e.g., compression) of the sample. The Hardness is defined by measuring this maximum force, as shown in FIG. 2B.

The term “cohesiveness” describes how well the product withstands a second deformation relative to its resistance under the first deformation. Cohesiveness is measured as the area of work during the second deformation (e.g., compression) divided by the area of work during the first deformation (e.g., compression); Area1/Area2, as shown in FIG. 29.

The term “springiness” describes how well a product physically springs back after it has been deformed during the first deformation (e.g., compression). The springback is measured at the down-stroke of the second deformation (e.g., compression). Springiness is measured as the time to reach 50% strain during the second deformation e.g., compression) divided by the time to reach 50% strain during the first deformation; Time 2/Time 1 in FIG. 2.

The term “gumminess” is a property of semi-solid products only and describes the energy required to macerate a semi-solid product before it can be swallowed. Gumminess is defined as hardness×cohesiveness, or hardness×area2/area1 shown in FIG. 2B.

The term “chewiness”, which is mutually exclusive with gumminess, applies only to solid products and is calculated as gumminess×springiness, or hardness×cohesiveness×springiness, or hardness×area2/area1×time 2/time 1 shown in FIG. 2B.

TPA of Exemplary Food Bars:

TPA measurements were performed using the following parameters:

Each sample was a rectangular of about 25 mm×25 mm and about 12 mm height.

For each sample, 3 compressions to 6 mm height were performed, with full ascendance therebetween. Preload of 0.1 N. Rate of compression: 100 mm/minute. The cylindrical probe had a diameter of 2 cm.

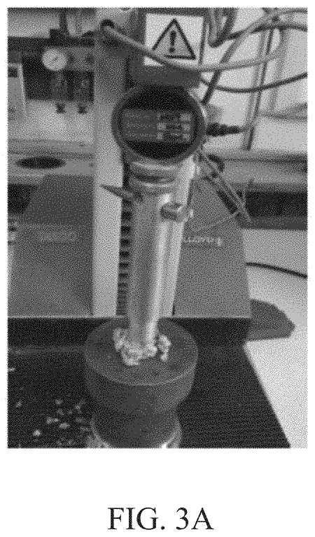

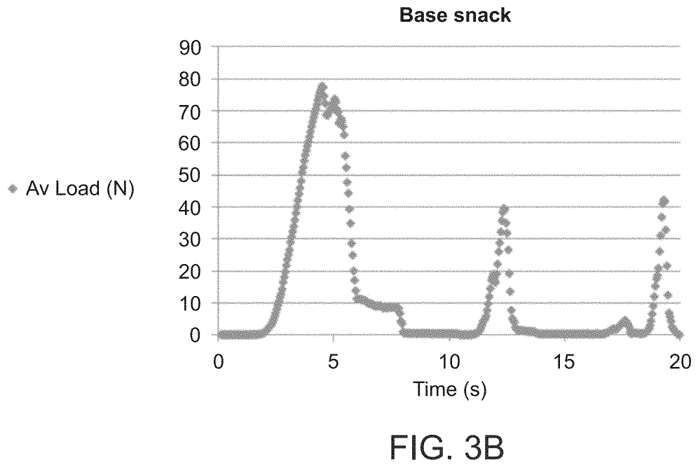

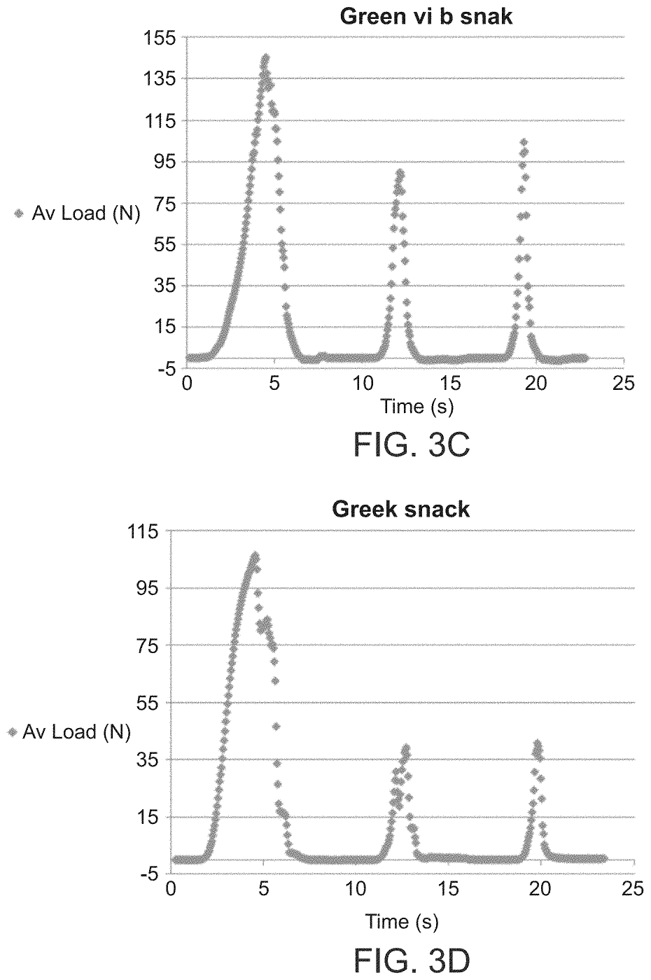

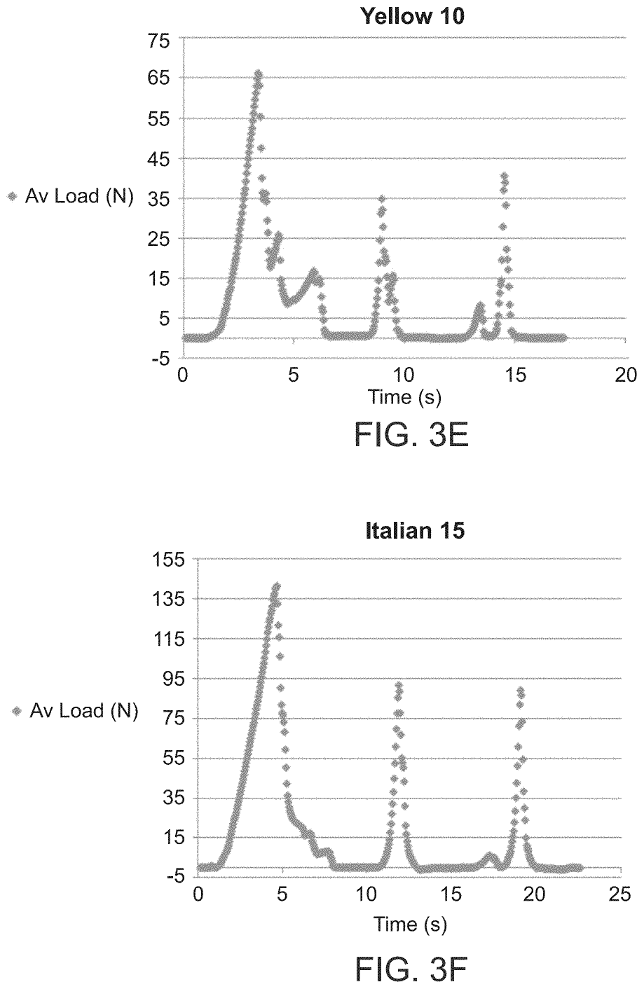

FIG. 3A presents a photograph of the experimental set up used in these measurements.

Table 7 below and FIGS. 3B-F present the data obtained for the food bars described in Example 2 as Samples 1-4 and 6, respectively.

TABLE 7

| Sample | | Hardness | Cohesive- | Gummi- | Springi- |
|---|---|---|---|---|---|
| No. | Recipe | (N) | ness | ness | ness |
| 1 | Base | 76.7 | 0.139 | 10.695 | 0.588 |
| 2 | Green | 142.9 | 0.241 | 34.439 | 0.4 |
| 3 | Greek | 106 | 0.129 | 13.733 | 0.77 |
| 4 | Yellow | 66.2 | 0.156 | 10.35 | 0.45 |
| 6 | Italian | 140 | 0.184 | 25.856 | 0.368 |

SEM Measurements:

SEM measurements were performed using Joel IT-100, operated at low vacuum mode at 15 KV. Each sample was applied directly on a conductive carbon tape without coating.

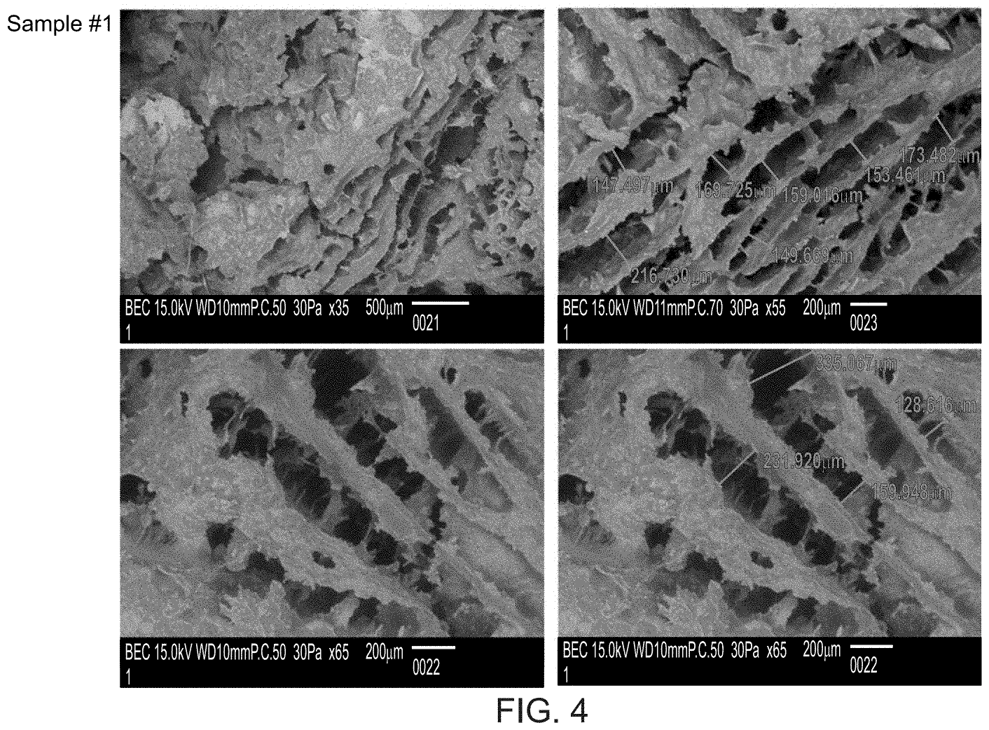

The obtained images are presented in FIGS. 4-9.

FIG. 4 presents images obtained for Sample 1 (“base” recipe), and shows that it features a layered morphology with pores featuring a characteristic shape and distribution and a size in the range of from 120 to 340 microns.

FIG. 4 presents images obtained for Sample 1 (“base” recipe), and shows that it features a layered morphology with pores featuring a characteristic shape and distribution and a size in the range of from 120 to 340 microns.

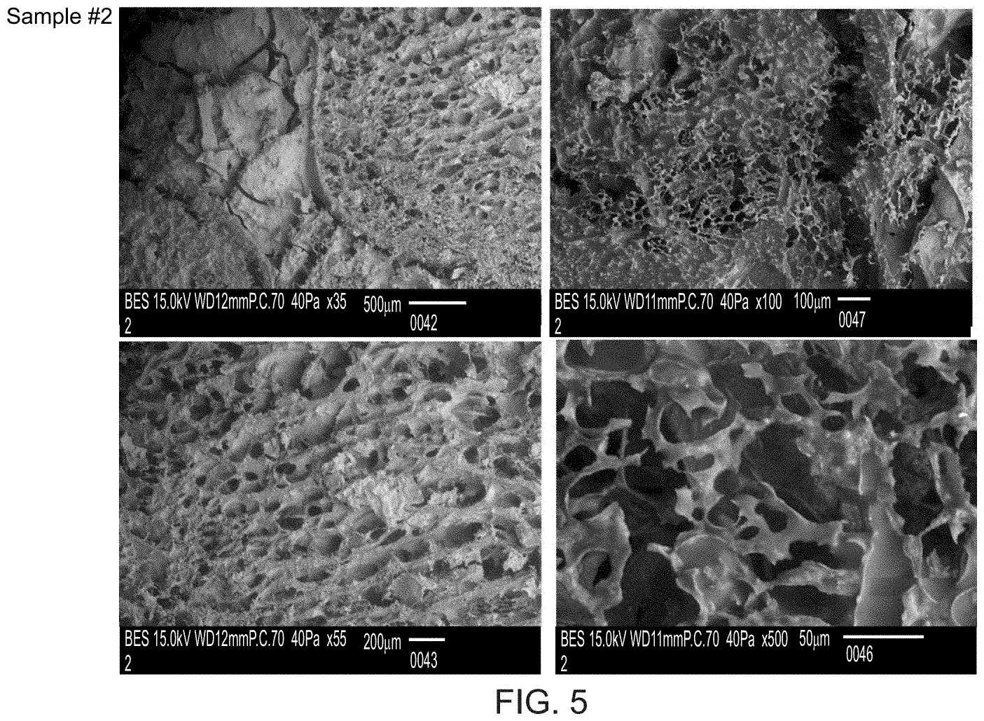

FIG. 5 presents images obtained for Sample 2 (“Green” recipe), and shows that it features a layered morphology with pores featuring a characteristic shape and distribution, similar to the “base” recipe (Sample 1). The pores are more uniform and feature a size in the range of from 70 to 100 microns.

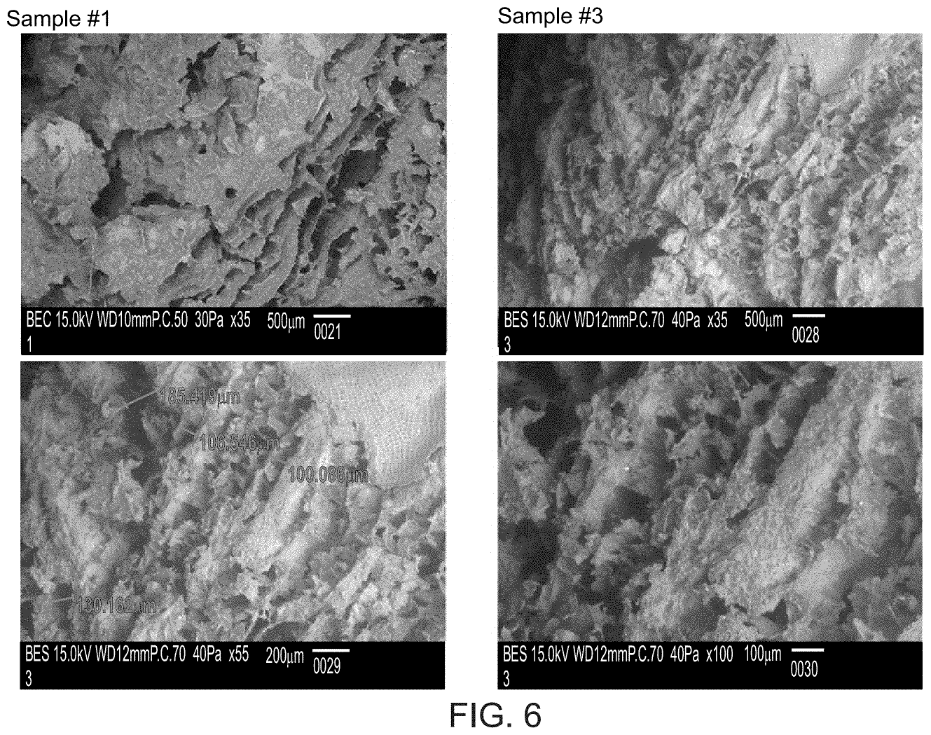

FIG. 6 presents images obtained for Sample 3 (“Greek” recipe), compared with images of Sample 1 (“base” recipe) and shows that it features a layered morphology with pores featuring a characteristic shape and distribution, similar to the “base” recipe (Sample 1). The pores feature a size in the range of from 70 to 200 microns.

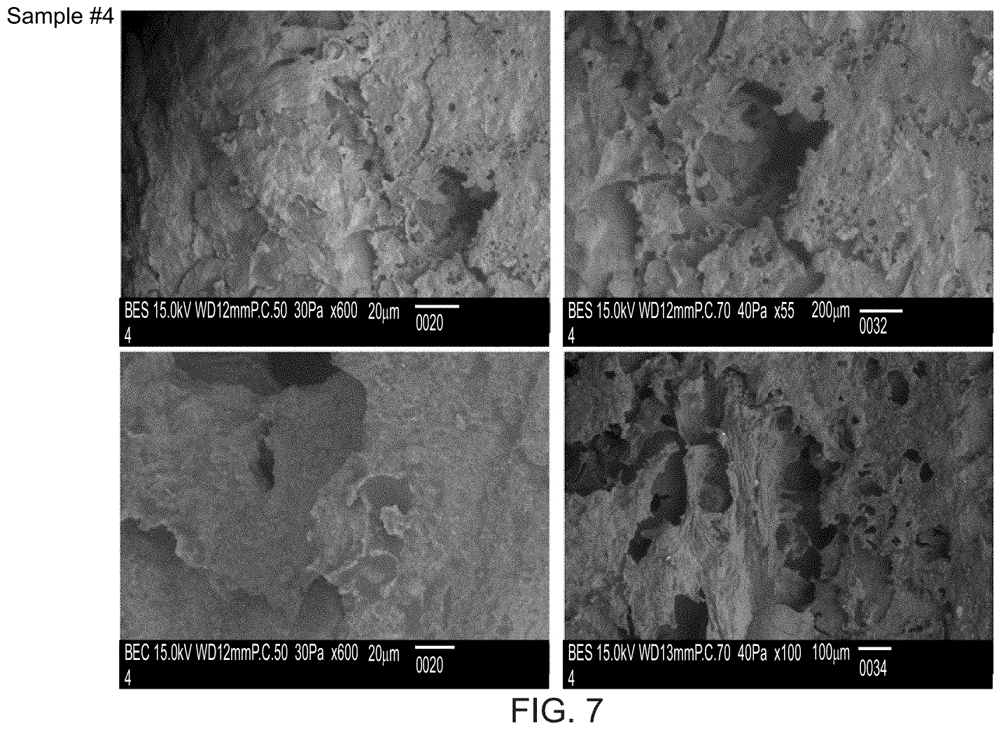

FIG. 7 presents images obtained for Sample 4 (“Yellow” recipe) and shows that it features a layered morphology, with pores featuring a characteristic shape and distribution, similar to the “base” recipe (Sample 1). The number of pores is however lower and their size is in the range of from 70 to 100 microns.

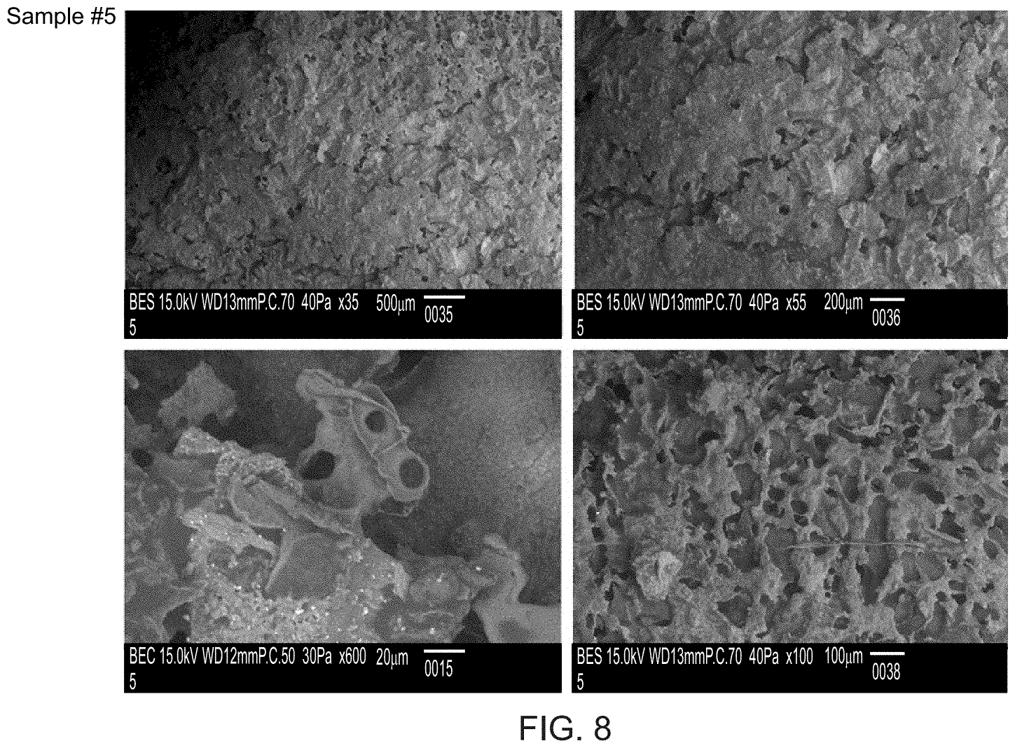

FIG. 8 presents images obtained for Sample 5 (“Red” recipe) and shows that it features a layered morphology with pores featuring a characteristic shape and distribution, similar to the “base” recipe (Sample 1). The pores are more uniform in size and shape and feature a size in the range of from 50 to 80 microns.

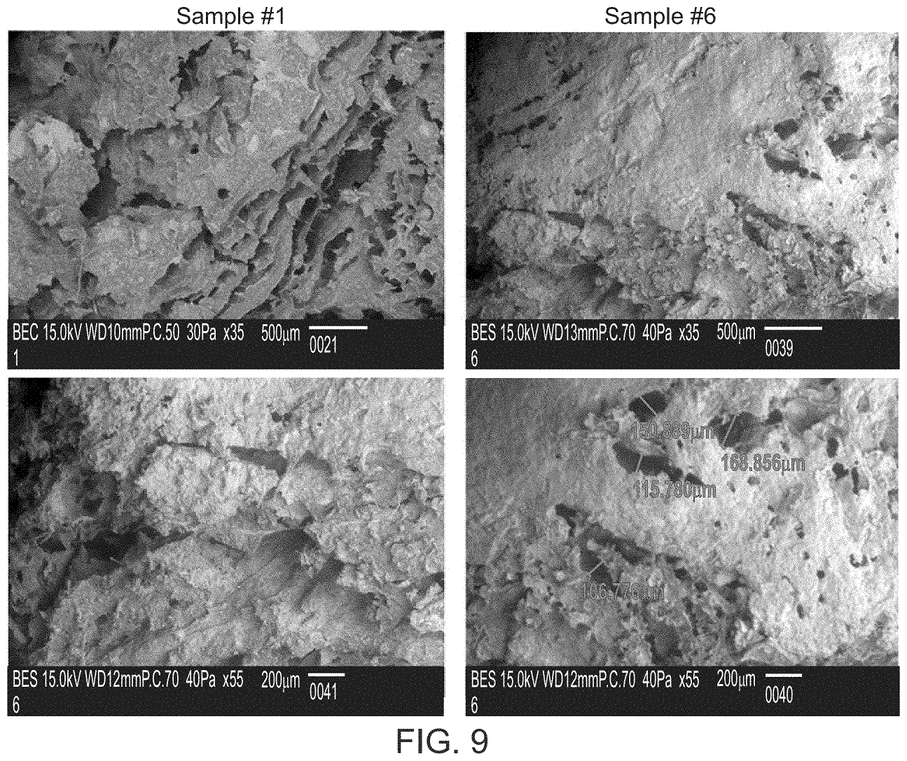

FIG. 9 presents images obtained for Sample 6 (“Italian” recipe), compared with images of Sample 1 (“base” recipe) and shows that it features a layered morphology with pores featuring a characteristic shape and distribution, similar to the “base” recipe (Sample 1). The morphology is more uniform and the pores feature a size in the range of from 50 to 110 microns.

The obtained SEM measurements demonstrate that all the tested food bars exhibit a porous structure, with pores size in a range of from about 50 to about 350 microns. The pores are generally elliptical, and can be divided into two populations:

“small” pores, featuring at least one dimension that is lower than 200 microns, and “big” pores featuring at least one dimension that is higher than 200 microns.

The averaged width-to-height ratio was calculated for each of the above pore populations in each of the tested Samples 1-6, and the obtained data is presented in Table 8 below.

TABLE 8

| | Big pores | Small pores |
|---|---|---|
| Sample | Average ratio | Average ratio |
| No. | width-to-height | width-to-height |
| 1 | 0.141 ± 0.074 | NA |
| 2 | 0.461 ± 0.030 | 0.7213 ± 0.1163 |
| 3 | 0.348 ± 0.276 | 0.7912 ± 0.2202 |
| 4 | 0.433 ± 0.297 | 0.5579 ± 0.3299 |
| 5 | 0.080 (SD NA) | 0.7901 ± 0.2815 |
| 6 | 0.348 ± 0.276 | 0.7912 ± 0.2202 |

As can be seen in Table 8, the porous structure of the exemplary bars of the present embodiments is characterized as featuring small pores, as defined above, having an averaged width-to-height ratio in a range of from 0.5-0.8, and large pores having averaged width-to-height ratio in a range of 0.08-0.5, and are therefore more elongated oval pores.

Water Activity:

Water activity was measured using Aqualab model 3 TE BY Decagon devices Inc. Pullamn, Wash., operated according to the Manufacturer's instructions, and was found to be within a range of from 0.06 to 0.3, as shown in Table 9 below.

TABLE 9

| Sample No. | Water Activity |
|---|---|
| 1 | |
| 2 | 0.156 |
| 3 | |
| 4 | 0.118 |
| 5 | 0.166 |
| 6 | 0.098 |

Water content was measured using oven drying method and was found to be less than less 7% by weight in all the tested food bars, as shown in Table 10 below.

TABLE 10

| Sample No. | Water Content |
|---|---|
| 2 | 3.53 |
| 4 | 5.61 |
| 5 | 5.87 |
| 6 | 2.92 |

Nutritional Values:

Nutritional values of the bars described as Samples 2-6 were measured and values per 100 grams are presented in Table 11 below.

TABLE 11

| | Sample 2 | Sample 3 | Sample 4 | Sample 6 | Sample 5 |
|---|---|---|---|---|---|
| | (GREEN) | (GREEK) | (YELLOW) | (ITALIAN) | (RED) |
| Energy | 547 | 542 | 529 | 562 | 561 |
| Protein | 13.5 | 15.7 | 13.9 | 17.3 | 15.7 |
| Carbohydrates (total) | 48.2 | 42.8 | 49.0 | 40.1 | 39.0 |
| Carbohydrate fibers | 7.0 | 7.2 | 6.7 | 7.9 | 8.0 |
| Sugars | 7.1 | 0.0 | 13.9 | 3.0 | 12.5 |
| Lactose | 0.9 | 0.0 | 0.5 | 0.7 | |
| Sugars (total) | 8.0 | 0.0 | 14.4 | 3.6 | 12-14 |
| Fats (total) | 35.0 | 35.8 | 32.4 | 38.8 | 39.8 |
| Saturated fats | 4.6 | 4.7 | 5.0 | 4.9 | 4.5 |
| sodium | 191 | 301 | 82 | 329 | 142 |

As can be seen in Table 11, the sugar content in all the tested bars does not exceed 15% by weight, and the fats and carbohydrate level exceeds 30% by weight.

Glycemic Index:

The Glycemic Index (GI) value of exemplary food bars made of whole round rice as the starch-containing substance as described in Examples 1 and 2 herein, was determined according to the standard ISO method ISO 26642:2010.

The glycemic index (GI) was proposed in the 1980s as a means to classify carbohydrate foods according to their effect on postprandial blood glucose responses. Low GI foods release their carbohydrate slowly and elicit a lower glycemic response while high GI foods are rapidly digested with a corresponding higher glycemic response. The rate of glucose absorption and extent and duration of elevated blood glucose levels induce many hormonal and metabolic changes that may affect health or disease parameters, and hence identifying low GI foods and the food factors responsible for the low GI of foods has become of great interest.

Using the classification of ISO 26642:2010, products with a glycemic index (GI) less than or equal to 55 are classified as being low GI, those with a GI of 56 to 69 are classified as medium, while those with a GI equal to or greater than 70 are high GI.

The “Italian” food bar described in Example 2 hereinabove and presented in Tables 6 and 6A (Sample 6), and the “Red” food bar, containing strawberry and beetroot, described in Example 2 hereinabove and presented in Tables 5 and 5A (Sample 5) were studied as follows.

Study Protocol:

Number of Subjects: A total of ten (10) subjects were studied. Using the t-distribution and assuming an average coefficient of variation (CV) of within individual variation of incremental area under the blood glucose curve (IAUC) values of 25%, n=10 subjects has 80% power to detect a 33% difference in IAUC with 2 tailed p<0.05.

Glycemic Index Testing: The protocol used followed the methods described in ISO 26642:2010—“Food products—Determination of the glycemic index and recommendation for food classification”.

The study used an open-label, randomized crossover design. Each subject underwent treatments on separate days, with each subject performing up to 3 tests per week separated by at least one day. On each test day, subjects came in the morning after a 10-14 hour overnight fast. After being weighed and having two fasting blood samples obtained by finger-prick five minutes apart, the subject then consumed a test meal within 15 minutes. Further blood samples were obtained at 15, 30, 45, 60, 90 and 120 minutes after the start of the test meal. Subjects remained seated quietly during the 2 hours of the test. After the completion of the test they were offered a snack and then allowed to leave.

The test meals consisted of a portion of the test food bar or dextrose containing 25 grams available carbohydrate (defined as total carbohydrate minus dietary fiber/non-digestible carbohydrates). The portion size of the test food was calculated based on the results of nutrition analysis described hereinabove in Table 11. Each subject was given a choice of a beverage (water, coffee or tea with 30 ml of 2% milk and non-caloric sweetener if desired) to consume with the test meal; the beverage chosen was kept the same for all test meals. The control meal was tested 2 times by all subjects.

Tested Food Preparation:

Dextrose Control: 27.3 grams of monohydrous dextrose (ADM Clintose® A Dextrose, Decatur, Ill., USA) was dissolved in 250 grams of water to yield a 25 gram-available carbohydrate solution.

Red food bar (Sample 5): 80.6-gram sample was weighed out and served to subjects.

Italian food bar (Sample 6): 77.6-gram sample was weighed out and served to subjects.

Table 12 below presents the nutrient content of the tested meals. All meals contained 25 grams of available carbohydrate.

TABLE 12

| Test | Weight | Protein | Fat | T CHO | Fiber | AvCHO |
|---|---|---|---|---|---|---|
| Meal | (grams) | (grams) | (gram) | (gram) | (gram) | (gram) |
| Dextrose | 27.3 | 0 | 0 | 25.0 | 0 | 25.0 |
| (Dex25) | | | | | | |
| Red Food bar | 80.6 | 12.66 | 32.10 | 31.45 | 6.45 | 25.0 |
| (Sample 5) | | | | | | |
| Italian Food bar | 77.6 | 13.43 | 30.12 | 31.13 | 6.13 | 25.0 |
| (Sample 6) | | | | | | |

Blood Samples:

Blood samples (2-3 drops each) were collected into 5 mL tubes containing a small amount of anticoagulant (sodium fluoride/potassium oxalate). The samples were mixed by rotating the tube vigorously and then refrigerated during the testing session. After completion of the test session, samples were stored at −20° C. prior to glucose analysis. Blood glucose analysis, using a YSI (Yellow Spring Instruments, OH) analyzer, took place within five days of collection.

Data Analysis:

Data were entered into a spreadsheet by 2 different individuals and the values compared to assure accurate transcription. IAUC values were calculated using the trapezoid rule, ignoring area beneath the baseline. For the purpose of the IAUC calculation, fasting glucose was taken to be the mean of the first measurement of the glucose concentration at times −5 and 0 minutes. Glucose was measured in the 0 minute fasting sample 2 times and the data used to determine the standard deviation (SD) of the analytical variation as follows:

SD=√(Σd2/n)

The GI was calculated by expressing each subject's glucose IAUC for the test food as a percentage of the same subject's mean response after reference meal and, if required, adjusting the GI to the glucose scale where glucose=100 and white bread=71. A second statistical analysis was done on the GI values after excluding those values >25D above the mean in which case excluded values were replaced by the mean of the remaining values and the error degrees of freedom in the ANOVA was reduced by the number of outliers excluded. After demonstrating significant heterogeneity, the differences between individual means were assessed using Tukey's test to control for multiple comparisons, with the criterion for significance being 2-tailed p<0.05. Means which differ by more than the least significant difference (LSD) differ significantly.

Results:

Ten (10) subjects (7 males and 3 females), aged 49±12 years with a body mass index of 26.3±3.5 kg/ma participated in the study.

Analytical Variation for Blood Glucose and within Subject Variation of Reference Food:

Analytical variation: Duplicate analysis was performed on 37 samples taken at 0 minutes. The mean±SD of blood glucose in these samples was 4.34±0.060 mmol/L for a CV of 1.4%, which is <3.6% and, thus, satisfactory (ISO 26642:2010). The mean±SD for the 40-5 and 0 minute samples was 4.38±0.121 mmol/L for a CV of 2.8%, which is greater than analytical variation because it reflects both analytical variation and minute-to-minute variation in blood glucose.

Within subject variation of reference food (dextrose control): There was no significant effect of order on the IAUC values after the repeated dextrose controls. The mean within-CV of the IAUC values after the 2 repeated dextrose control tests was 11.8%. The tests appeared to be technically satisfactory, as judged by the average within-subject variation of glycemic responses for the repeated dextrose control tests. Values less than 30% are considered to be satisfactory (ISO 26642:2010).

Adverse Events and Protocol Deviations:

All test meals were well tolerated and no adverse events were reported.

Blood Glucose Response:

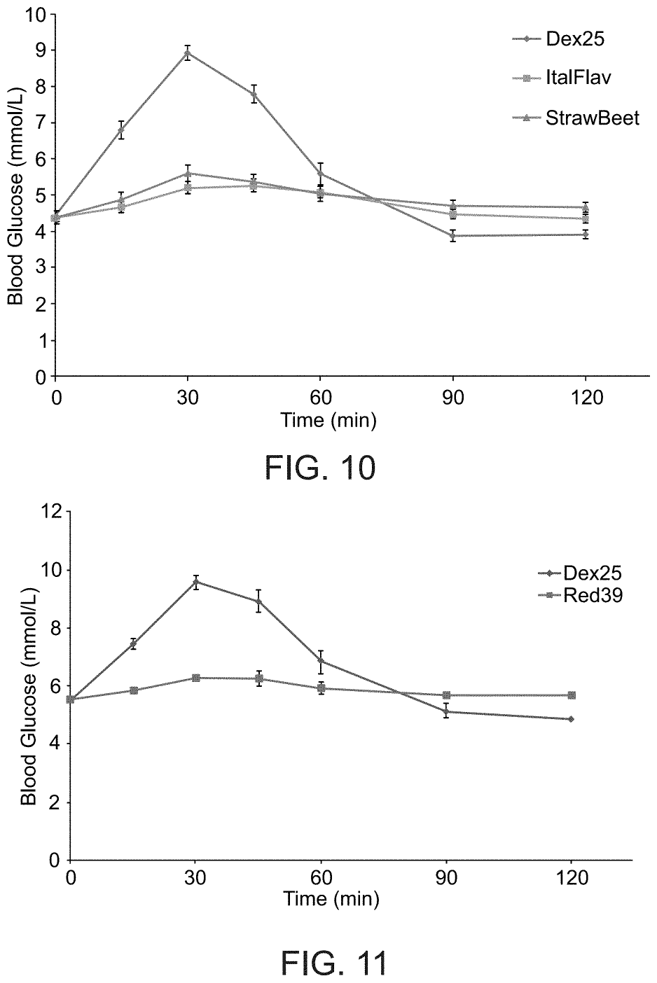

FIG. 10 presents the postprandial glucose responses to the Red food bar, Sample 5 (StrawBeet), the Italian food bar, Sample 6 (ItalFlav) and the dextrose control (Dex25) (mean of 2 meals) 10 subjects each. All meals contained 25 grams of available carbohydrate. Data are expressed as Mean±SEM. As can be seen in FIG. 10, mean fasting blood glucose was similar before each test meal within each series. After 30 minutes, much higher blood glucose level was observed with the dextrose control. Similar values were observed after 120 minutes.

Table 13 below presents the Incremental Area Under the Curve (IAUC), Glycemic Index and Glycemic Index Category as determined in the study. Results are given as Mean±SEM. GI values are given by category (Category: high (GI≥70), medium (56≥GI≤−69), or low (GI≤55) (ISO 26642:2010). The GI values are expressed on the glucose scale where the GI of glucose=100 and white bread=71.

TABLE 13

| | IAUC | | GI |
|---|---|---|---|
| Test Meal | (mmol × min/L) | GI | Category |
| Dextrose (Dex25) | 187.4 ± 18.1^{a} | 100^{a} | High |
| Red Food bar (Sample 5) | 68.1 ± 6.4^{b} | 38 ± 4^{b} | Low |
| Italian Food bar (Sample 6) | 57.7 ± 5.8^{b} | 32 ± 3^{b} | Low |

^{ab}Numbers within the same column with a different letter in the superscript are statistically significantly different (P < 0.05).

As can be seen, exemplary food bars of the present embodiments exhibited a low glycemic index.

### Example 4

### Food Bars Made of Quinoa and White Round Rice

Additional exemplary food bars were prepared using a mixture of quinoa and round white rice (sticky sushi rice) as the starch-containing substance, using the exemplary general procedure described in Example 1 hereinabove.

Tables 14 and 14A below present the ingredients included in a “red” food bar that comprises rice and quinoa starch and olive oil with additional liquid and/or solid food additives and flavoring agents, before freeze-drying (Table 14) and after freeze-drying (Table 14A). The “red” food bar of Table 14A is also referred to herein as Sample 7.

The weight percentages indicated in Table 14 below refer to the mixture obtained after all the ingredients are mixed and before freeze-drying.

The weight percentages indicated in Table 14A below refer to the final product obtained after freeze-drying the mixture as described in corresponding Table 14.

A “rice and quinoa preparation” is a starch-containing preparation as described herein, prepared by mixing sticky sushi rice and quinoa (at a weight ratio of about 2:3) with water, at a weight ratio of about 1:3 (relating to the total weight of the rice and quinoa), at about 90° C. for one hour.

TABLE 14
Type of

| Ingredient | Ingredient | Weight % | |
|---|---|---|---|
| Starch-containing | Rice and quinoa preparation | 22-30 | (e.g., 23-27) |
| preparation | | | |
| Oily substance | Olive oil | 3-6 | (e.g., 4-4.5) |
| | Almond paste | 2-6 | (e.g., 3-4) |
| Liquid food | Lemon concentrate | 0.1-1 | (e.g., 0.1-0.3) |
| ingredient | | | |
| Food ingredient | Maple syrup | 2-6 | (e.g., 3-5) |
| | Sunflower seeds | 6-10 | (e.g., 8-9) |
| | Roasted Almond cubes | 6-10 | (e.g., 8-9) |
| | (e.g., 3 × 6 mm) | | |
| | Beetroot (cooked) | 6-14 | (e.g., 9-10) |
| | Strawberry (frozen) | 30-40 | (e.g., 35-38) |
| | salt | 0.1-0.5 | (e.g., 0.2-0.3) |

| | | |
|---|---|---|
| Anti-oxidant | GreenOX ® | 0.001-0.01 |

TABLE 14A
Type of

| Ingredient | Ingredient | Weight % | |
|---|---|---|---|
| Starch-containing | Rice and quinoa preparation | 10-20 | (e.g., 12-17) |
| preparation | | | |
| Oily substance | Olive oil | 8-15 | (e.g., 10-12) |
| | Almond paste | 5-15 | (e.g., 8-12) |
| Liquid food | Lemon concentrate | 0.1-1 | (e.g., 0.1-0.5) |
| ingredient | | | |
| Food ingredient | Maple syrup | 5-15 | (e.g., 8-12) |
| | Sunflower seeds | 15-25 | (e.g., 20-24) |
| | Roasted Almond cubes | 15-25 | (e.g., 20-24) |
| | (e.g., 3 × 6 mm) | | |
| | Beetroot (cooked) | 2-10 | (e.g., 2-5) |
| | Strawberry (frozen) | 5-15 | (e.g., 5-10) |
| | salt | 0.1-1 | |
| Anti-oxidant | GreenOX ® | 0.01-1 | (e.g., 0.05-0.5) |

A mixture containing about 70% by weight of the rice and quinoa preparation, olive oil, almond paste and the antioxidant was vigorously blended and the remaining rice and quinoa preparation was thereafter added to the mixture. The almonds cubes and sunflower seeds were roasted gently and added to the emulsion. Cooked beetroot and strawberries were cut in small cubes (approximately 0.5 cm×0.5 cm each) and added to the emulsion. The maple syrup, lemon concentrate and salt were thereafter added, the resulting mixture was mixed to obtain even distribution, and was thereafter subjected to freeze-drying as described herein.

### Example 5

### Characterization

An exemplary food bar as described in Example 4 and referred to herein as Sample 7 was characterized as described in Example 3 hereinabove.

Water Activity:

Water activity of the tested product was determined as described in Example 3 above and was 0.22.

Nutritional Values:

Nutritional values 2-6 were measured and values per 100 grams are presented in Table 15 below.

TABLE 15

| | |
|---|---|
| Energy | 572 |
| Protein | 15.3 |
| Carbohydrates (total) | 37.7 |
| Carbohydrate fibers | 7.0 |
| Sugars | 15.6 |
| Fats (total) | 41.6 |
| Saturated fats | 4.9 |
| sodium | 257 |

As can be seen in Table 15, the sugar content is about 15% by weight, and the fats and carbohydrate level exceeds 30%, and even 40% by weight.

Glycemic Index:

The glycemic Index of the product was determined according to ISO 26642:2010 as described in Example 3 above. 10 subjects participated in the study.

FIG. 11 presented the postprandial glucose responses to the tested food bar, Sample 7 (Red39), and the dextrose control (Dex25) (mean of 2 meals) 10 subjects each. All meals contained 25 grams of available carbohydrate. Data are expressed as Mean±SEM. As can be seen in FIG. 11, mean fasting blood glucose was similar before each test meal within each series. After 30 minutes, much higher blood glucose level was observed with the dextrose control. Similar values were observed after 120 minutes.

The Glycemic Index and Glycemic Index Category were determined as 29±7 and Low, respectively. Results are given as Mean±SEM. The GI values are expressed on the glucose scale where the GI of glucose=100 and white bread=71.

TPA Measurements:

TPA measurements were performed using an exemplary TPA set-up for measuring textural properties of a piece of a cheddar cheese as shown in FIG. 3A and further detailed in Example 3 hereinabove.

TPA measurements were performed using the following parameters:

Each sample was a rectangular (dice) of about 25 mm×25 mm and about 13 mm height. The cylindrical probe had a diameter of 2 cm.

For each sample, 3 compressions to 6 mm height were performed, with full ascendance therebetween. Preload of 0.1 N. Rate of compression: 100 mm/minute.

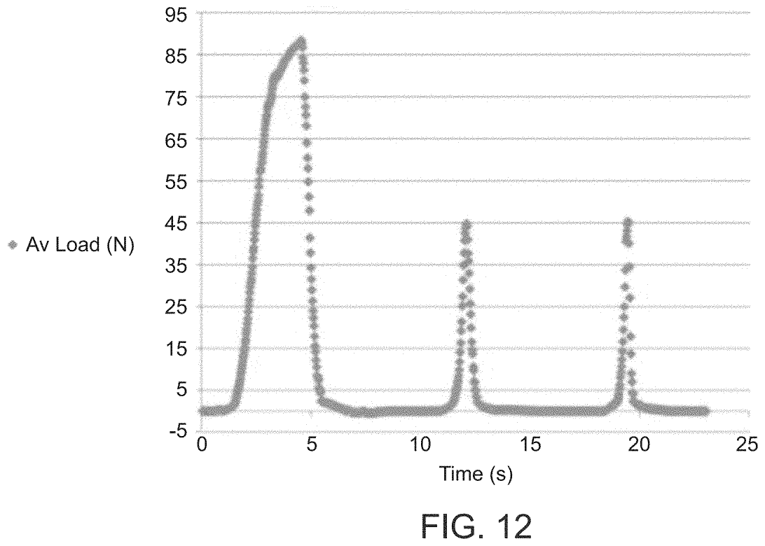

FIG. 12 presents the data obtained for Sample 7 in these measurements.

Table 16 below presents the data extracted from the TPA measurements for Sample 7, as explained in Example 3 hereinabove.

TABLE 16

| Sample No. | Hardness (N) | Cohesiveness | Gumminess | Springiness |
|---|---|---|---|---|
| 7 | 87.7 ± 15.6 | 0.0999 | 8.74 | 0.64 |

SEM Measurements:

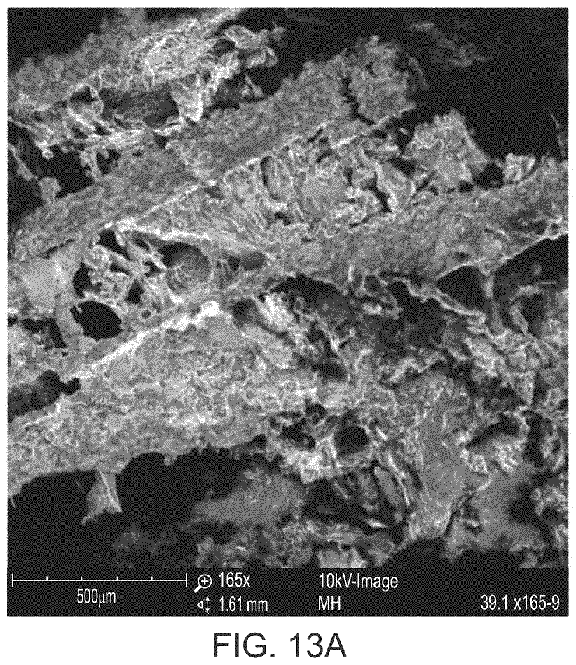

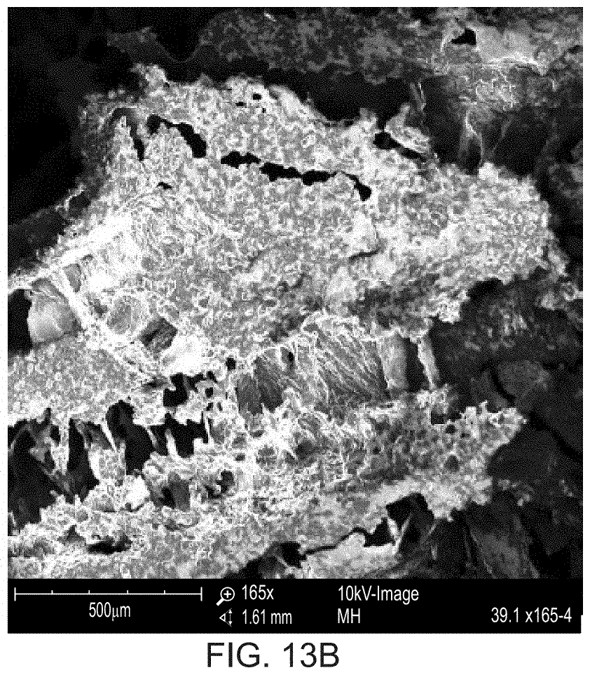

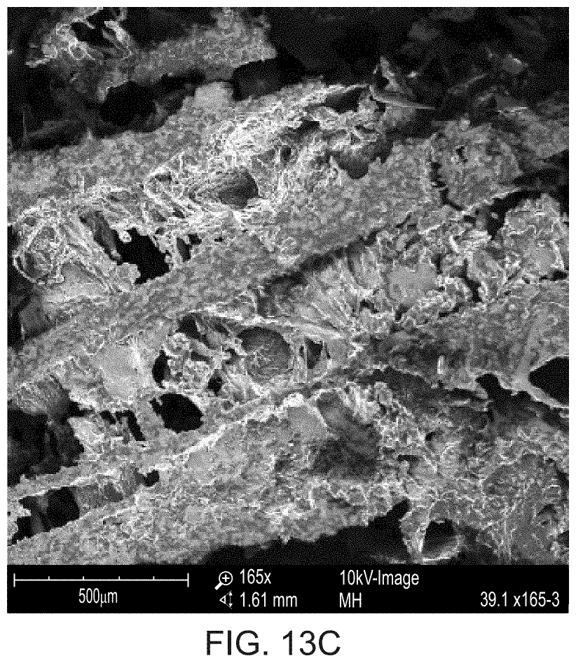

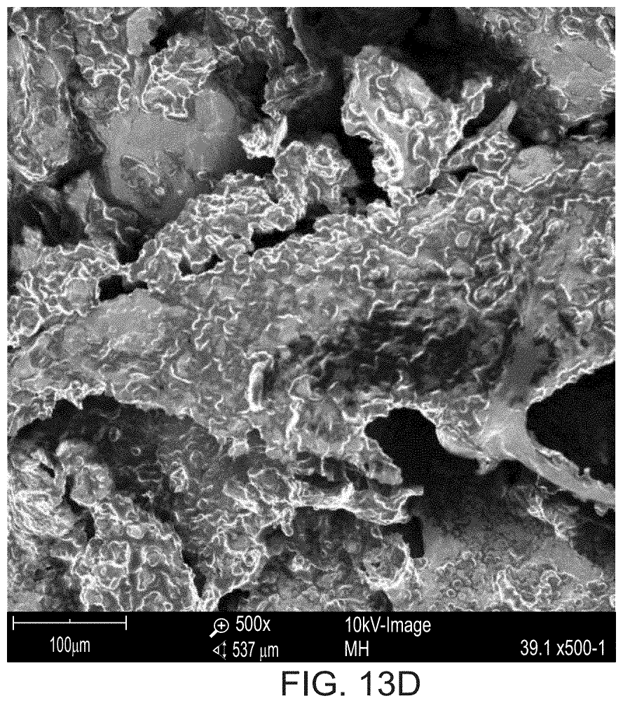

SEM measurements of Sample 7 were performed as described in Example 3 hereinabove. The obtained images are presented in FIGS. 13A-D and show a typical pore size in a range of from 80 to 100 microns. The features of pores are similar to those described for the “base” product, Sample 1.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1-49. (canceled)

50. A freeze-dried food product comprising:
gelatinized starch, in an amount of from 15% to 30%, or from 15% to 25%, by weight of the total weight of the food product; and
an oily food substance, in an amount of at least 5%, or at least 8%, by weight, of the total weight of the food product,
the food product being a porous product.

51. The freeze-dried food product of claim 50, further comprising a food ingredient.

52. The freeze-dried food product of claim 50, wherein said gelatinized starch is obtainable from a starch-containing substance.

53. The freeze-dried food product of claim 52, wherein said starch-containing substance is or comprises rice.

54. The freeze-dried food product of claim 52, wherein said starch-containing substance comprises quinoa.

55. The freeze-dried food product of claim 52, wherein said starch-containing substance comprises a mixture of rice and quinoa.

56. The freeze-dried food product of claim 55, wherein a weight ratio of said rice and said quinoa ranges from 1:1 to 1:3.

57. The freeze-dried food product of claim 52, wherein an average amylose content in said starch-containing substance is no more than 20% by weight of the total weight of the starch-containing substance.

58. The freeze-dried food product of claim 50, characterized by at least one of:
pores having a size in a range of from 10 to 500, or from 50 to 350, microns; and/or
water activity lower than 0.5, or lower than 0.4, or lower than 0.3; and/or
carbohydrate content of at least 20%, or at least 30% by weight, of the total weight of the food product; and/or
fat content of at least 10% by weight of the total weight of the food product; and/or
a total amount of sugars of less than 20% by weight of the total weight of the food product.

59. The freeze-dried product of claim 50, featuring at least one of:
hardness, as defined by TPA measurements, of from 30 N to 200 N, or from 60 N to 150 N;
cohesiveness, as defined by TPA measurements, of from 0.05 to 0.3, or from 0.08 to 0.25;
gumminess, as defined by TPA measurements, of from 5 N to 50 N, or from 8 N to 40 N;
springiness, as defined by TPA measurements, of from 0.2 to 1, or from 0.3 to 0.8; and/or.
a Glycemic Index, as determined by ISO 26642:2010, lower than 50, or lower than 40.

60. A freeze-dried food product comprising:
gelatinized starch obtainable from a starch-containing substance that comprises a mixture of rice and quinoa; and
an oily food substance, in an amount of at least 5%, or at least 8%, by weight, of the total weight of the food product,
the food product being a porous product.

61. The freeze-dried food product of claim 60, wherein an amount of said gelatinized starch is from 15% to 30%, or from 15% to 25%, by weight, of the total weight of the food product.

62. The freeze-dried food product of claim 60, further comprising a food ingredient.

63. The freeze-dried food product of claim 60, wherein an average amylose content in said starch-containing substance is no more than 20% by weight of the total weight of the starch-containing substance.

64. The freeze-dried food product of claim 60, characterized by at least one of:
pores having a size in a range of from 10 to 500, or from 50 to 350, microns; and/or
water activity lower than 0.5, or lower than 0.4, or lower than 0.3; and/or
carbohydrate content of at least 20%, or at least 30% by weight, of the total weight of the food product; and/or
fat content of at least 10% by weight of the total weight of the food product; and/or
a total amount of sugars of less than 20% by weight of the total weight of the food product.

65. The freeze-dried product of claim 60, featuring at least one of:
hardness, as defined by TPA measurements, of from 30 N to 200 N, or from 60 N to 150 N;
cohesiveness, as defined by TPA measurements, of from 0.05 to 0.3, or from 0.08 to 0.25;
gumminess, as defined by TPA measurements, of from 5 N to 50 N, or from 8 N to 40 N;
springiness, as defined by TPA measurements, of from 0.2 to 1, or from 0.3 to 0.8; and/or
a Glycemic Index, as determined by ISO 26642:2010, lower than 50, or lower than 40.

66. A freeze-dried food product comprising carbohydrates and fats, wherein a total amount of said carbohydrates is at least 20% or at least 30% by weight of the total weight of the food product, and a total amount of said fats is at least 10% or at least 20% by weight of the total weight of the food product, and wherein a total amount of sugars in the food product is lower than 20% by weight of the total weight of the food product, the food product being a porous product.

67. The freeze-dried food product of claim 66, wherein said carbohydrates comprise a gelatinized starch.

68. The freeze-dried food product of claim 66, wherein said total amount of said fats ranges from 10% to 50% by weight of the total weight of the food product.

69. The freeze-dried food product of claim 66, comprising at least one oily food substance.

70. The freeze-dried food product of claim 69, wherein an amount of said oily food substance is at least 5% by weight of the total weight of the food product.

71. The freeze-dried food product of claim 67, wherein said gelatinized starch is obtainable from a starch-containing substance which is or comprises rice.

72. The freeze-dried food product of claim 67, wherein said starch-containing substance comprises a mixture of rice and quinoa.

73. The freeze-dried food product of claim 67, wherein an average amylose content in said starch-containing substance is no more than 20% by weight of the total weight of the starch-containing substance.

74. The freeze-dried food product of claim 66, characterized by at least one of:
pores having a size in a range of from 10 to 500, or from 50 to 350, microns; and/or
water activity lower than 0.5, or lower than 0.4, or lower than 0.3; and/or
carbohydrate content of at least 20%, or at least 30% by weight, of the total weight of the food product; and/or
fat content of at least 10% by weight of the total weight of the food product; and/or
a total amount of sugars of less than 20% by weight of the total weight of the food product.

75. The freeze-dried product of claim 66, featuring at least one of:
hardness, as defined by TPA measurements, of from 30 N to 200 N, or from 60 N to 150 N;
cohesiveness, as defined by TPA measurements, of from 0.05 to 0.3, or from 0.08 to 0.25;
gumminess, as defined by TPA measurements, of from 5 N to 50 N, or from 8 N to 40 N; and/or
springiness, as defined by TPA measurements, of from 0.2 to 1, or from 0.3 to 0.8.

76. The freeze-dried product of claim 66, featuring a Glycemic Index, as determined by ISO 26642:2010, lower than 50, or lower than 40.

77. A process of preparing a freeze-dried food product, the process comprising:
heating a mixture of a starch-containing substance and water at a temperature of from 50 to 99° C. or from 80 to 99° C. to thereby obtain a starch-containing preparation comprising a gelatinized starch and water;
blending said starch-containing preparation with an oily food substance, to thereby obtain a homogeneous mixture comprising said starch-containing preparation; and
subjecting said mixture to freeze-drying,
thereby preparing the freeze-dried food product.

78. The process of claim 77, wherein an amount of said oily food substance ranges from 5% to 20% by weight of the total weight of said homogeneous mixture comprising said starch-containing preparation.

79. A freeze-dried food product prepared or obtainable by the process of claim 77.
